(19) United States
(12) Patent Application Publication
(10) Pub. No.: US 2013/0334049 A1
(43) Pub. Date: Dec. 19, 2013

(54) MULTI-COLOR DETECTION SYSTEM FOR MULTIPLEXED CAPILLARY ELECTROPHORESIS

(71) Applicant: Advanced Analytical Technologies, Inc., Ames, IA (US)

(72) Inventors: Wei Wei, Ames, IA (US); Ho-Ming Pang, Ames, IA (US)

(21) Appl. No.: 13/905,277

(22) Filed: May 30, 2013

Related U.S. Application Data
(60) Provisional application No. 61/654,493, filed on Jun. 1, 2012.
(60) Provisional application No. 61/759,130, filed on Jan. 31, 2013.

(51) Int. Cl. G01N 27/447; G01N 21/64

(52) U.S. Cl. CPC G01N 27/44721; G01N 21/6486
USPC 204/603; 250/458.1; 250/226

(57) ABSTRACT

A multi-wavelength detector for a multiplex capillary electrophoresis system comprising a linear filter placed in between the capillary detection windows and a 2-dimensional detector. The linear filter is oriented such that the change in wavelength of the filter is in the direction of flow of the fluid within the capillary detection windows. And a method for time shift correction and to merge all peaks into a single overlapped peak.

### CROSS-REFERENCE TO RELATED APPLICATIONS

This application is a non-provisional application of U.S. Ser. No. 61/654,493 filed Jun. 1, 2012 and U.S. Ser. No. 61/759,130 filed Jan. 31, 2013, herein incorporated by reference in its entirety.

### FIELD OF THE INVENTION

This invention relates to a multiplexed capillary electrophoresis (CE) multi-color fluorescence detection system for the separation and detection of substances possessing fluorescent properties, e.g., fluorescently DNA, RNA, amino acids, carbohydrates, fatty acids, proteins, etc.

### BACKGROUND OF THE INVENTION

Capillary electrophoresis (CE) systems use electric fields to separate molecules within narrow-bored capillaries filled with conductive buffers or gel matrices. Samples are injected into the capillary tubing via the application of a high electric field or by physical injection (i.e. application of a vacuum or pressure). Sample molecules are detected by a variety of methods while traveling through the detection window. Ultraviolet (UV) absorption detection is a common detection method since many analytes have a functional group that absorbs in the UV region. However, because of the use of narrow-bore capillaries (≦100 μm I.D.) which results in a short detection path, as well as high background levels of UV light, the detection limit of this method is typically limited to about 10⁻⁵ molar (M), which is not sensitive enough for many applications. Laser induced fluorescence (LIF) is used in capillary electrophoresis for samples that naturally fluoresce or for those that are chemically modified to fluoresce. LIF provides much lower detection limits than the UV-based methods because the detection of emitted, fluorescent light of a different wavelength than the excitation light enables a drastic reduction in level of background light. Detection limits using LIF are typically 10⁻¹⁰ to 10⁻¹² M, which is 5-7 orders of magnitude lower than for UV-based CE methods. Existing LIF systems are expensive, difficult to maintain, and require extensive alignment procedures to properly adjust the laser, capillary array, and detector. It is preferable to use detection schemes that enable the use of low cost lasers and eliminate the need for complex alignment procedures involving the light source, capillary array, and detector.

Other light sources can be used for induced fluorescent detection, such as a light emitting diode (LED), thermal radiation lamps such as the tungsten or carbon-filament lamp, or atomic emission lamps such as mercury, zinc, or sodium. Historically, the use of light sources other than lasers has not matched the sensitivity of the LIF method. For example, the detection limits for fluorescently labeled DNA using an LED as a light source has historically been 10⁻⁷M to 10⁻⁹M or a factor of 10 to 100,000 less sensitive than LIF.

There is a need for CE systems that use low-cost lasers without the need for complex and costly alignment procedures. Alternatively, there is a need for CE systems that use light sources other than lasers, such as LEDs, but that allow for sensitivities close to LIF detection.

In order to improve the sample throughput, a plurality of capillaries is used to analyze multiple samples simultaneously. These multiplexed capillary array electrophoresis systems are used in many commercial DNA sequencers and DNA fragment analyzers. Most of them use a laser as the light source, including confocal scanning laser induced fluorescence (e.g. U.S. Pat. No. 6,270,644), sheath flow detectors (e.g. U.S. Pat. Nos. 5,468,364 and 6,048,444), side-entry optical excitation geometry (e.g., U.S. Pat. Nos. 5,582,705 and 5,741,411), and fiber optics for excitation and emission collection (U.S. Pat. No. 6,870,165). Other multiplexed CE systems use LEDs as a light source, such as those described in U.S. Patent Application serial number US 2010-0140505 A1.

Multi-Color detectors for CE are used in a variety of applications. For example, Sanger-type DNA sequencing requires the measurement of four different wavelength regions to discriminate the four different nucleotide bases, each derivatized with a different fluorescent tag. The dominant signal from each different wavelength region determines different nucleotide bases. For example, you might have a four-color system, in which each of four colors corresponds to a unique wavelength C, T, A, or G. In some cases, a filter wheel has been used to measure different wavelength regions sequentially by rotating the filter wheel to the desired filters. The filter wheel method is not efficient since only one wavelength region is measured at any given time. U.S. Pat. No. 6,461,492 uses beam splitters to divide the light emission into multiple beams with multiple detectors for multi-wavelength detection. This method measures only one capillary signal at a time and requires a scan of each detection window sequentially for multiplexed capillary array electrophoresis operation. In addition, this method requires the use of multiple detectors for measurement which substantially increases the cost and maintenance. U.S. Pat. No. 6,048,444 reveals a method that uses a single detector to measure four different wavelength regions simultaneously. The fluorescent signal is split by an image splitter prism and projected into a two-dimensional detector. The wavelength is selected by using four different filters. However, since the fluorescent emission is split to four regions before filtering, it suffers from low light detection efficiency and is not suitable for light sources such as LEDs. U.S. Pat. No. 5,998,796 discloses a method of using a transmission grating for multi-wavelength analysis for multiplexed capillary array electrophoresis. U.S. Pat. No. 5,741,411 reveals a method based on a tilted filter to split the fluorescent signal into two for two-wavelength fluorescent measurements while using a single two-dimensional detector. However, this method was limited to two wavelengths, and is not suitable for DNA sequencing, which requires at least a 4 color detection system.

In addition to sequencing, multiple-wavelength fluorescent detection systems are also used for “short-tandem repeat analysis” (STR) and the closely related method, multi-locus variable number tandem repeat analysis (MLVA) or simple sequence repeat (SSR) analysis. In these applications, a DNA ladder as well as several DNA amplicons corresponding to several different amplified loci on the genomic DNA are injected into a single capillary. One color is used to detect the DNA ladder, while other colors are used to detect specific fluorescently-labeled STR fragments corresponding to the amplified multi-loci on the genomic DNA. Multiple STR fragments corresponding to multiple gene locations can be analyzed in a single capillary. The Federal Bureau of Investigation (FBI) “Combined DNA Index System” (CODIS), commonly employs a 5-color instrument with a multi-fluorescent detection system to detect the STR amplicons corresponding to 13 loci on the human genome. Newer versions of the FBI CODIS-type system may use more than 14-26 loci on the human genome, which necessitates the need to develop multi-color systems that can detect more than 6 colors simultaneously. New CE systems with the ability to detect 7 or more colors simultaneously are preferred. Even more preferable are CE detection systems capable of measuring 8 or more colors simultaneously.

It is therefore desirable to develop a low-cost, simple, multiplex, multi-color detection electrophoresis system that enables the use of low-cost light sources (lasers or LED's) giving detection sensitivities that are similar those obtained with current LIF systems based on expensive laser systems. To meet the needs of next-generation human identification and MLVA-type applications, it is also desirable to have a multi-color fluorescent detection system for CE that enables the simultaneous detection of 7 or more colors. It is even more preferable to have a detection system that can detect 8 or more colors simultaneously.

### SUMMARY OF THE INVENTION

Embodiments of the invention provide a high sensitivity and high throughput capillary electrophoresis multi-wavelength fluorescence detection system. A multiplex capillary electrophoresis detection system is comprised of a light source for inducing fluorescence emission, a 2-dimensional detector such as a CCD detector, a plurality of capillaries, a plurality of capillary detection windows, and a linear variable filter oriented in such a way that the change in wavelength of the filter is parallel to the direction of flow in the capillaries. The linear variable filter (LVF) is placed anywhere between the capillary windows and the 2-dimensional detector. The location of the LVF may be directly against the capillary windows, or preferably, directly against the CCD camera. The LVF is oriented in such a way that for a given species migrating through the capillary detection window, a difference in the intensity of fluorescence emission as a function wavelength is detected in the direction of analyte flow on a 2-dimensional detector. As an analyte passes through the capillary detection window, the wavelength corresponding to the maximum corrected intensity is an indication of the fluorescent color of the compound. For example a DNA strand derivatized with Fluorescein (FAM) has an emissions maximum of about 521 nm. If this FAM-derivatized analyte passes through the capillary detection window, the CCD detector coupled with the LVF will detect a maximum corrected intensity at about 521 nm.

In order to achieve maximum sensitivity of detection, a broad area capillary window may be illuminated. The length of the capillary windows that may be illuminated by laser, LED or other light sources may be from 0.02 mm to 13 millimeters (mm) preferably, the length of capillary windows illuminated is from 1 mm to 7 mm. An alternate preferred range of illuminated lengths is 1 mm to 5 mm. An alternate preferred range is from 0.02 mm to 1 mm. A preferred specific length of illumination is 6 mm.

Illumination of a large capillary window volume, coupled with the imaging of the array windows onto a linear filter in the direction of flow causes an apparent time shift of different color species as they move through the capillary. For example, red light-emitting compounds are detected several seconds after blue-light emitting compounds (or vice-versa, depending on the orientation of the linear filter). This complicates the interpretation of the electropherogram, and this time shift must be corrected using computer algorithms. The general method for correcting this time shift is to determine the velocity as a function of electrophoresis time for species moving through the capillaries, and then to correct the saved 2-dimensional data set so that the all wavelengths of an analyte moving past the detection window are observed at the same apparent time.

### DESCRIPTION OF THE DRAWINGS

FIG. 1 is a schematic view of a multiplex CE system showing the light source, capillary array, and detector.

FIG. 2 is an isometric view of the invention showing the linear variable filter.

FIG. 3 is another isometric view of the invention with the filter holder and clamp removed.

FIG. 4 is a view of a linear variable filter.

FIG. 5A is an isometric view of the invention showing the orientation of the capillary, linear filter, and 2-dimensional detector, where the linear filter is located adjacent to the capillary windows.

FIG. 5B is a schematic view of the invention showing the orientation of the capillary, linear filter, and 2-dimensional detector, where the linear filter is located adjacent to a CCD camera.

FIG. 6 shows the output of the 2-dimensionnal detector array.

FIGS. 7A-F show output of the 2-dimensional CCD array, as a sample is passing through capillary windows.

FIG. 8A shows processed output of the 2-dimensionaal CCD array, showing 4-color electropherograms before a time-shift correction.

FIG. 8B shows the processed output of the 2-dimensional CCD array, showing the 4-color electropherogram after a time-shift correction.

FIG. 9 shows the flow-diagram for performing a time-shift correction using a computer program.

FIG. 10 shows a single 1-second snapshot of the 2-dimensional detector.

FIG. 11 shows an electropherogram of an allelic ladder displayed as the monitored intensity of a single column of y-axis pixels corresponding to a single capillary on the CCD detector.

FIG. 12A shows the pixels corresponding to a single capillary, summed over the entire duration of an electropherogram.

FIG. 12B shows the electropherogram of an allelic ladder plotted using Pixel location A and Pixel location B (two different points corresponding to two different times on the linear variable filter).

FIG. 12C shows a close-up of FIG. 12B.

FIG. 13A shows a plot of time difference (of each fragment) vs time.

FIG. 13B shows a close-up of FIG. 12C.

FIG. 14A shows a simple linear-least squares fit of the time-difference vs. time plot.

FIG. 14B shows a “Robust Regression” of the time-difference vs. time plot.

FIG. 15 shows a time-difference vs. time plot of an electropherogram.

FIG. 16A shows an electropherogram derived from a single-pixel on the 2-dimensional detector.

FIG. 16B shows an electropherogram using multiple pixels with time-correction

FIG. 16C shows an electropherogram using multiple pixels without a time correction.

FIG. 17A shows a time-corrected multi-color electropherogram

FIG. 17B shows a time-corrected multi-color electropherogram using a color-matrix deconvolution to extract a single color from the multi-color electropherogram.

FIG. 18 is an example velocity curve calculated from the migration of peaks in a capillary.

FIG. 19 is an example of two electropherograms generated from 2 different pixel locations in the direction of flow.

FIG. 20 is an example of two electropherograms generated from 2 different pixel locations in the direction of flow.

FIG. 21 is the signal distribution of the pixels in the direction of flow for multiple capillaries as a function of time for a peak migrating through the capillary window.

### DETAILED DESCRIPTION OF THE INVENTION

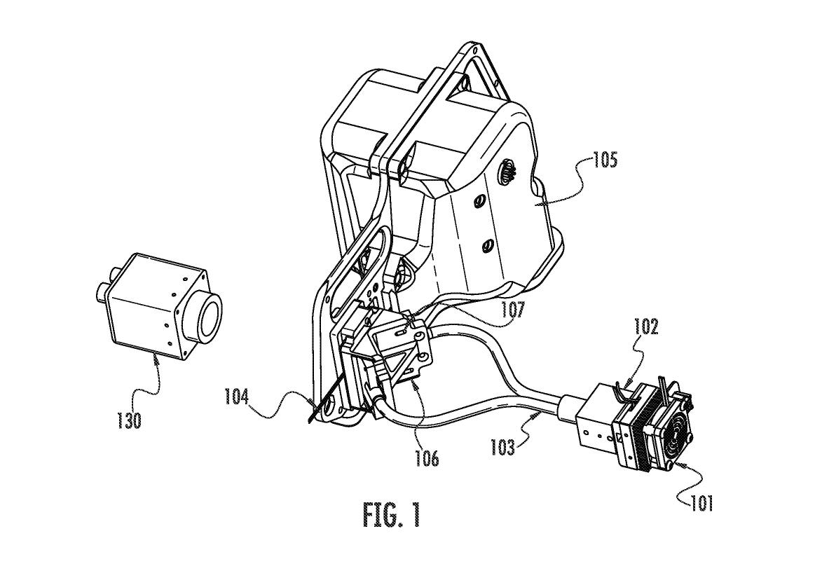

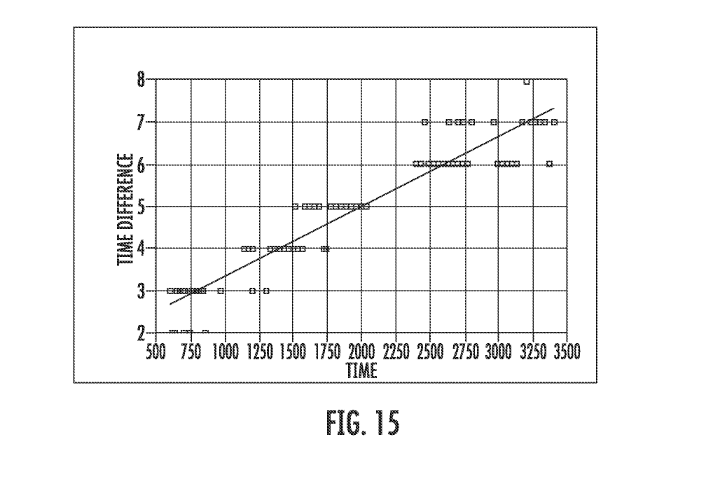

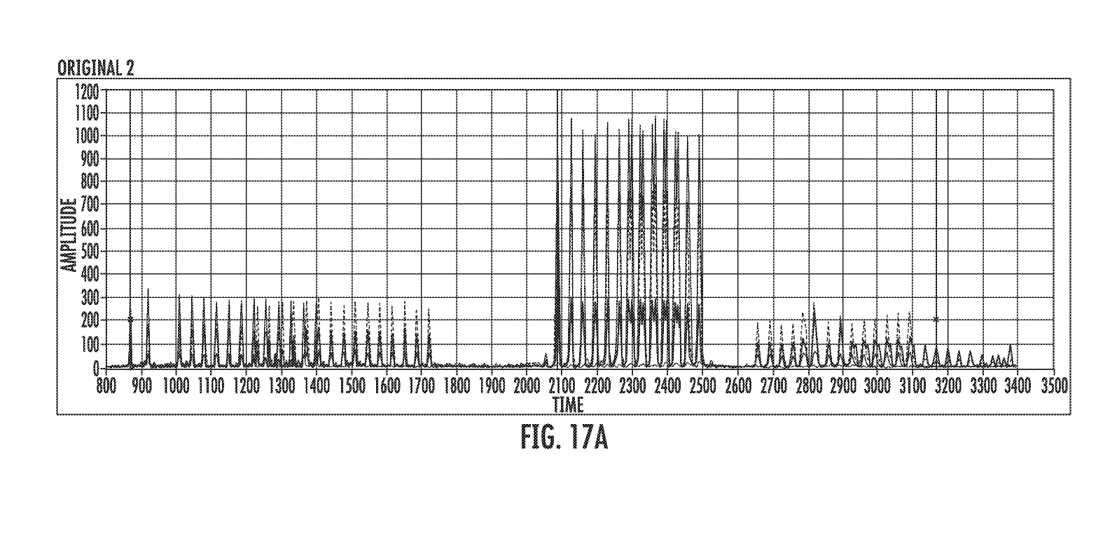

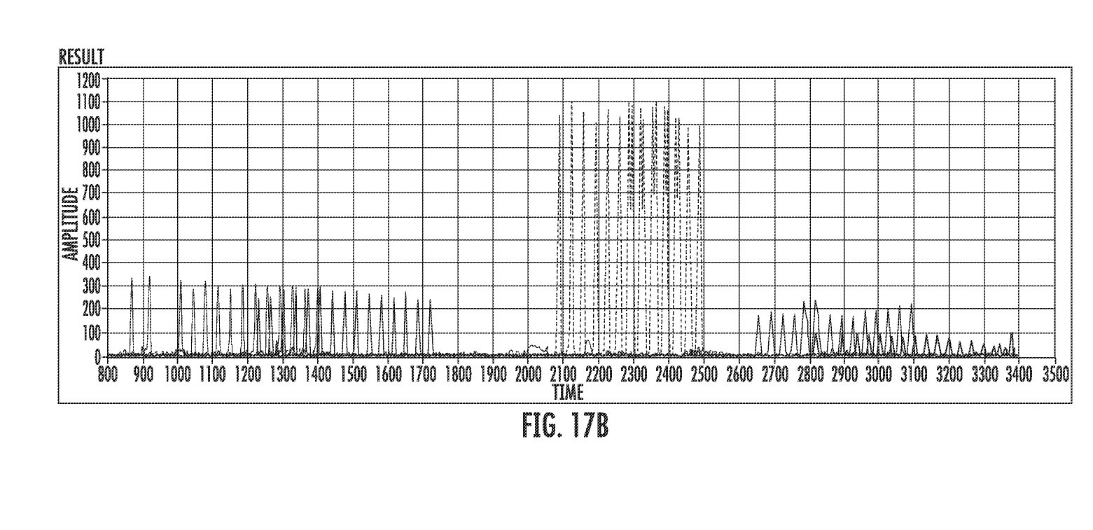

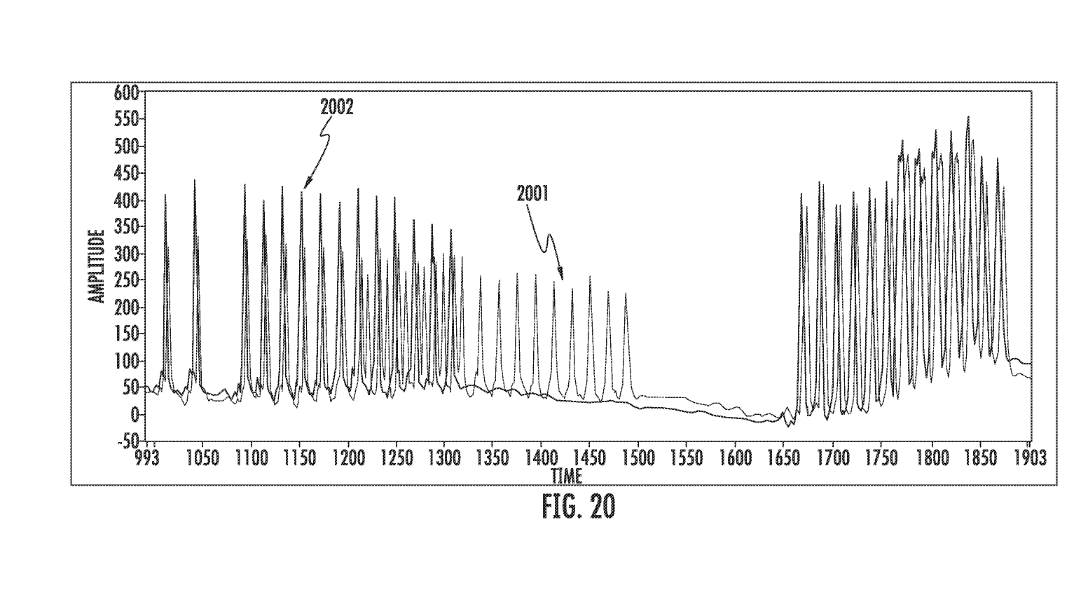

A specific embodiment of the invention is described in connection with FIGS. 1-21. It is, however, to be understood FIGS. 1-21 are exemplary only and that other physical embodiments of the system may be employed without departing from the scope and spirit of the invention.

The invention includes a fluorescent detection system for multiplexed capillary electrophoresis. Referring to FIG. 1, the detection system includes a sample vessel 104 (e.g., a capillary or a plurality of capillaries) in which a sample is placed. Multiple capillaries may be used to increase the sample analysis throughput. At the detection location, all capillaries are packed in parallel to allow simultaneous excitation and fluorescent detection. The light source 102 could be a light emitting diode, gas discharge lamp, thermal emission lamp (i.e. black body radiation source) laser, or any other light source. In the preferred embodiments, one or more lasers or LED's are used as light source. A combination of LED's and lasers may be used. In a preferred embodiment, two LEDs are used as a light source. Another embodiment uses a single laser with primary emission wavelength 532 nm. Another embodiment uses a single laser with a primary emission wavelength of 488 nm. Another preferred embodiment uses at least two lasers with primary emission wavelengths of 473 and 532 nm. Alternatively, some embodiments use light sources with wavelengths ranging from about 450 nm up to about 640 nm. Shown here is also a fan 101 for cooling of the light source. An optional optical fiber bundle 103 is used to guide the light from the light source to the capillary windows. Shown here are two fiber bundle light guides, but a single fiber-bundle light guide is also acceptable. Multiple light sources may be used, each with their own separate light-guides. For example, two lasers may be used, such as a 473 nm laser, and a 532 nm laser, each with their own light guide to direct light to the capillary windows. Three lasers may be used, such as a 473 nm diode laser, a 532 nm diode laser, and a 630 nm diode laser, each with their own light guide to direct light towards the capillary windows. Alternatively, light of different wavelengths may be combined or mixed prior to entrance or coupling into a fiber light guide. Any appropriate focusing and optical shaping methods may be used to couple the light from the light sources into the fiber light guides. Light from the light source may be directly aimed at the capillary windows without the use flexible or rigid fiber bundle light guides, using optional lenses or optional mirrors to direct and focus the light onto and towards the capillary windows. The light from the light source may be shaped with lenses, mirrors, or other light shaping methods prior to impingement onto the capillary windows. A light-guide holder 106 places the angle of incident light to the sample capillaries at between 10 degrees and 80 degrees. Optional fiber orientation plates 107 change the shape of the cylindrical optical fiber bundle to a rectangular shape, to optimize the irradiation of the capillary detection windows. Other geometries and shapes of the fiber orientation plates may be used, such as circular, square, triangular, oval, or any other geometric shape. A capillary array cartridge 105, which may be optionally temperature controlled, houses the plurality of capillaries. A preferable embodiment uses a heated compartment for the capillary array and capillary windows. It is preferable to heat the capillaries and capillary windows to at least 30-70 degrees C. Other embodiments heat the entire length of the capillary array, including the capillary windows, and optionally the reservoir. A 2-dimensional detector 130 detects fluorescent emission from the sample as it passes through the capillaries 104. Preferably, the 2-dimensional detector is a CCD array.

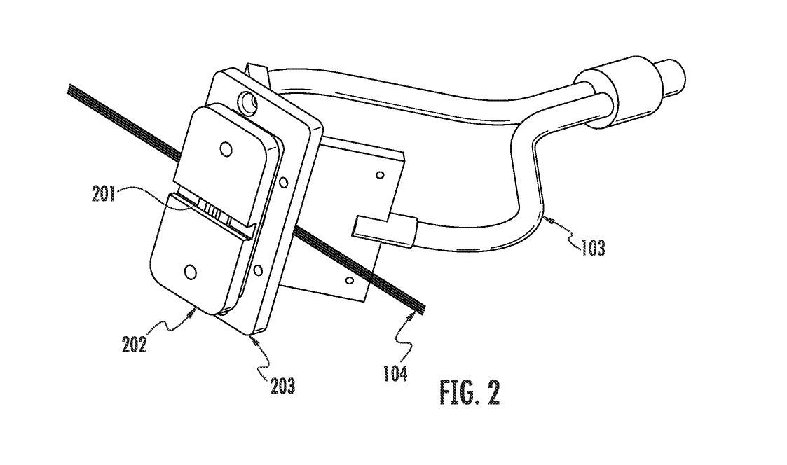

FIG. 2 shows another view of the present invention, showing the fiber bundle light guides 103, plurality of capillaries 104, a filter holder 203, a filter clamp 202, and a linear variable filter, 201, which is clamped between the filter and filter holder. The plurality of capillaries shown here is a bundle of 4 capillaries. Preferred embodiments of the invention include a plurality of at least 8 capillaries. An even more preferred embodiment is a plurality of at least 12 capillaries. An even more preferred embodiment is a plurality of 16 to 24 capillaries. Multiplex capillary bundles of 48 or 96 capillaries may also be used. The linear filter is oriented so that the change in output wavelength of the fluorescence emission intensity as a function of wavelength is directed along the flow path of the capillaries.

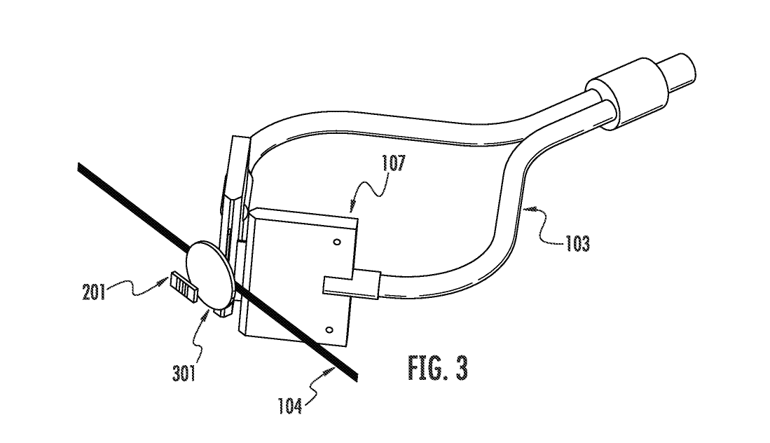

FIG. 3 shows a view of the present invention with the filter holder and filter clamp removed. Fiber light guides 103 connected are connected to light guide plates 107 to re-shape the light from the circular shape of the fiber bundle to a rectangular shape. This allows for more efficient irradiation of the plurality of capillaries, 104. One or more filters 301 are used to remove the fluorescent excitation wavelength, which leaves only the fluorescence emission light from the samples in the capillaries to travel to the linear filter 201. The linear filter is oriented so that the change in wavelength of the filter is in the direction of flow of fluids in the capillaries.

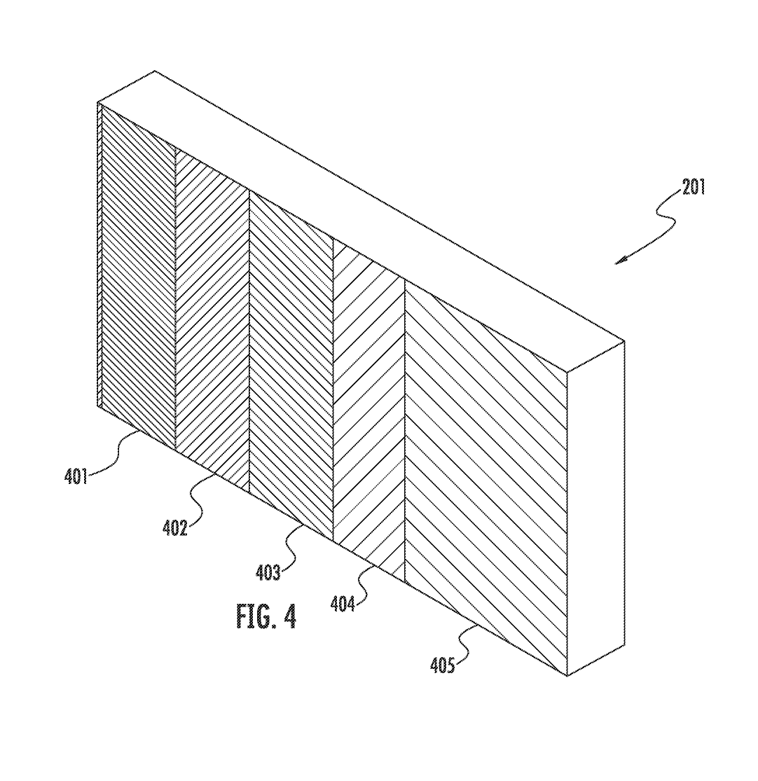

FIG. 4 shows the general concept of a linear filter 201, with white light on the backside, and a spectrum of colors on the front side, going from short wavelengths (blue color, left side of figure, 401) to longer wavelengths (red color, right side of figure, 405). The linear filter 201 is oriented such that the direction of flow of the capillary is in the same direction as the change in wavelength of the linear filter.

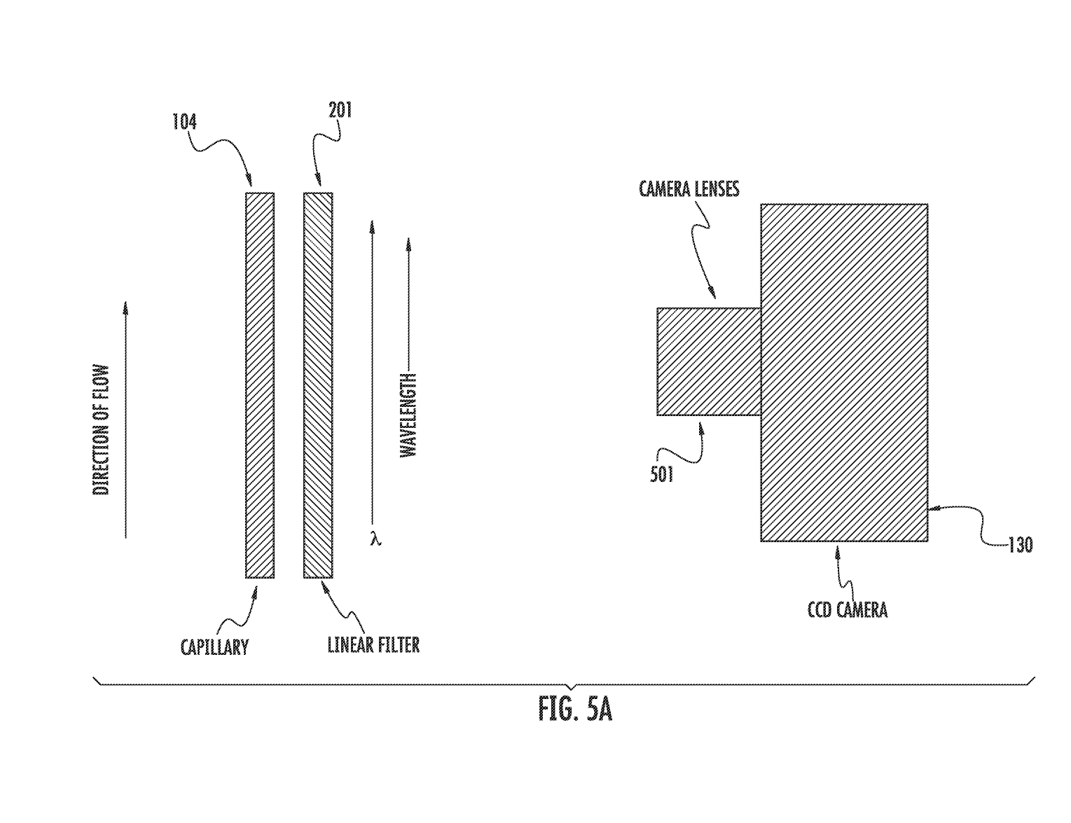

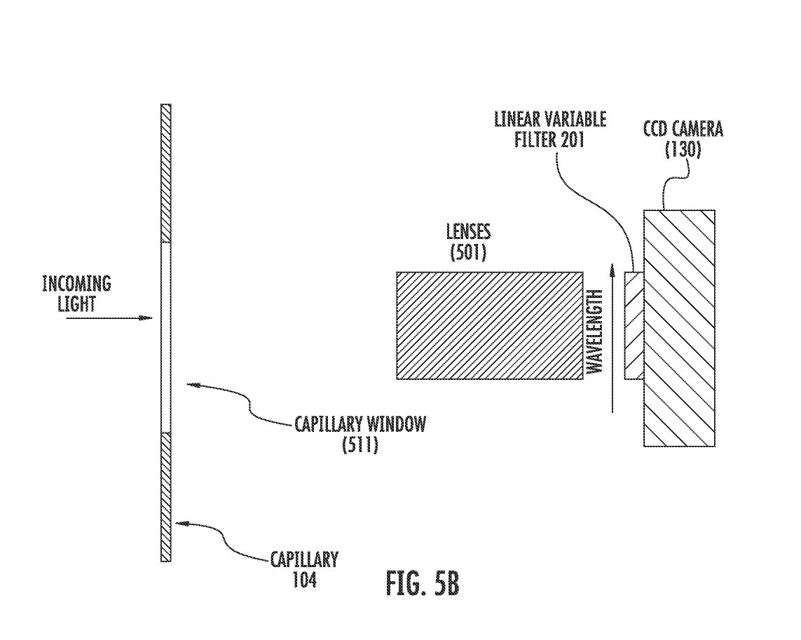

FIG. 5A depicts the orientation of the linear filter 201, capillaries 104, camera 130, and camera lens(es) 501. The linear filter is oriented such that the change in wavelength of the linear filter is in the direction of fluid flow in the capillaries. FIG. 5B depicts the orientation of the capillaries 104, linear filter 201 and two-dimensional detector, when the linear detectors is located adjacent a CCD camera.

When the linear filter is placed directly against the capillary array windows, the length of the capillary detection window is preferably about as long than the length of the linear filter. For example, if a 6 mm linear filter is used, then it is preferable that the length of the clear capillary windows is about 6 mm, so that the entire length of the capillary window is imaged onto the linear filter.

Alternate embodiments of the invention have a window length that is shorter than the linear filter length, where a subset of the linear filter wavelength range is superimposed onto the capillary windows. For example, assume a linear filter wavelength range is from 400 to 700 with a corresponding filter length of 6 mm. If this is superimposed onto a capillary window that is 3 mm in length, then a subset of the linear filter wavelength may be used, corresponding to 3 mm of length of the filter. For example, a wavelength range corresponding to 400-550 nm can be used or 550 nm-700 nm, or 500-650 nm. In this example, any 3 mm length of the capillary window may be superimposed onto the linear filter.

If the linear variable filter is located adjacent to the CCD camera, a short capillary window length may be imaged with appropriate lenses onto a longer dimension of a linear variable wavelength filter. For example, if the linear variable filter is 6 mm in length (corresponding to a wavelength range of 400-700 nm), and the capillary window is 1 mm in length, then the 1 mm length may be imaged onto the 6 mm linear filter in such a way that the 1 mm length of the capillary window corresponds to 400-700 nm. Alternatively, if the LVF is located adjacent to the CCD, any length of capillary detection window may be imaged onto the LVF, using appropriate lenses. For example, a 20 mm window length could be image onto a 6 mm LVF length.

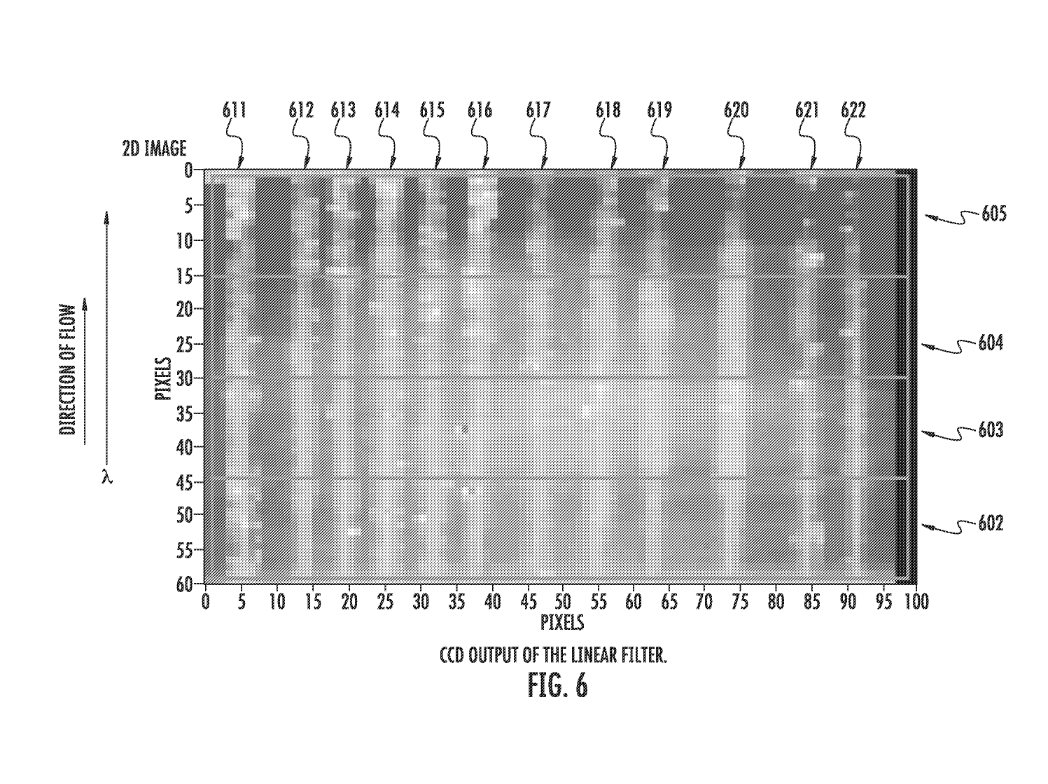

A two-dimensional pixelated detector, 130 is used, (FIG. 6) with the y-axis corresponding to the direction of flow of the capillaries, and the x-axis perpendicular to the flow direction of the capillary. The x-axis of the pixelated detector has pixels that correspond to the capillary walls, the space inside the cavity of each capillary, and the space between the capillaries. The x-axis pixels are selected such that only the pixels corresponding to interior of the capillaries are used for detection of fluorescently emitted light. Optionally, the pixels corresponding to both the capillary walls and the interior of the capillaries are used for the detection of fluorescently emitted light. The length of the x-axis is such that at least 1 pixel per capillary are used. It is preferable to have at least 2 pixels per capillary, with at least one pixel defining the interior of the capillary, and at least one pixel defining each wall of the capillary. For detection of light in the direction of flow of the capillaries (y-axis) a minimum of 4 y-axis pixels must be available for light detection, with at least 1 pixel dedicated to each color of a 4-color system. It is preferable to have at least 40 pixels for the detection of light in the y-axis. It is even more preferable to have at least 60 pixels for the detection of light in the y-axis direction. The linear filter oriented with the y-axis of the detector may have output wavelengths ranging from 400 nm to 800 nm. Preferable ranges are from about 450 nm to about 750 nm. An even more preferable range is from about 500 nm to about 700 nm. Another preferable range is from about 500 nm to about 800 nm. The y-axis may be divided into an equal number of zones corresponding to the number of detection colors for the multi-color detector. For a 4-color system, the number of pixels is divided into 4 equal lengths, with at least 1 pixel per segment. For 60 pixels in the y-axis direction, a 4-color system corresponds to 4 separate 15-pixel lengths. For a 6-color system with a total of 60-pixels in the y-axis direction, each separate color corresponds to 10 pixels in length. For a 10-color system with a total of 60 pixels in the y-axis direction, the number of pixels is divided into 10 equal lengths or zones of 6 pixels each which are monitored simultaneously with the 2-dimensional detector. Alternatively, zones with different or mixed pixel numbers can be used. For example, in a 4 color system with 60 y-pixels, the pixels can be divided into 4 groups consisting of 5, 10, 15, and 25 pixels. Any number of mixed pixel numbers can be used to define the different zones used for monitoring the colors of fluorescent light. Groups of pixels with defined gaps of non-detection may be used. For example, in a 4-color system with 60 y-pixels, the pixels can be divided into 4 groups of 5 for four detection zones, with 4 gaps of 9 or 10 pixels between the detection zones that are not used for detection.

FIG. 6 shows the output of a 2-dimensional CCD detector. The direction of flow of electrophoresis is in the y-direction. In this case, the image captures the output of 12 capillaries, labeled as 611 (capillary 1), 612 (capillary 2), 613 (capillary 3), 614 (capillary 4), 615 (capillary 5), 616 (capillary 6), 617 (capillary 7), 618, capillary 8, 619, capillary 9, 620 (capillary 10), 621, (capillary 11) and 622 (capillary 12). The output of the linear filter is continuous from a wavelength of about 500 nm at pixel “60” of the y-axis to a wavelength of 700 at pixel “0” of the y-axis. In this case, the y-axis is broken into 4 distinct regions, 602, 603, 604, 605, to result in a 4 color system. The summation of all wavelength intensities in each zone is simultaneously monitored. For example, the sum of wavelengths corresponding to the y-axis pixel range of 60 pixels to 45 pixels (zone 602) is defined as “blue”. The sum of wavelengths corresponding to the y-axis pixel range of 45 to 30 pixels (zone 603) is defined as “green”. The sum of wavelengths corresponding to the y-axis pixel range of 30 to 15 pixels (zone 604) is defined as “yellow”. The sum of wavelengths corresponding to the y-axis pixel range of 15 to 0 pixels (zone 605) is defined as “red”.

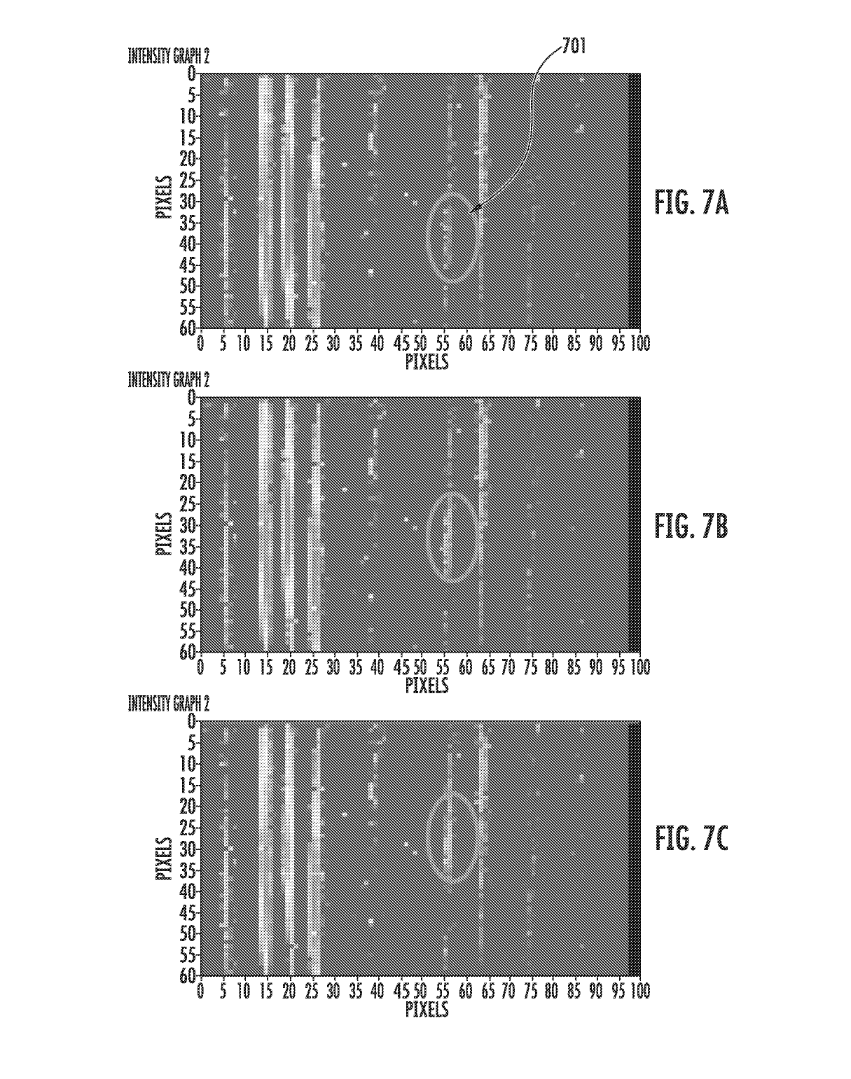

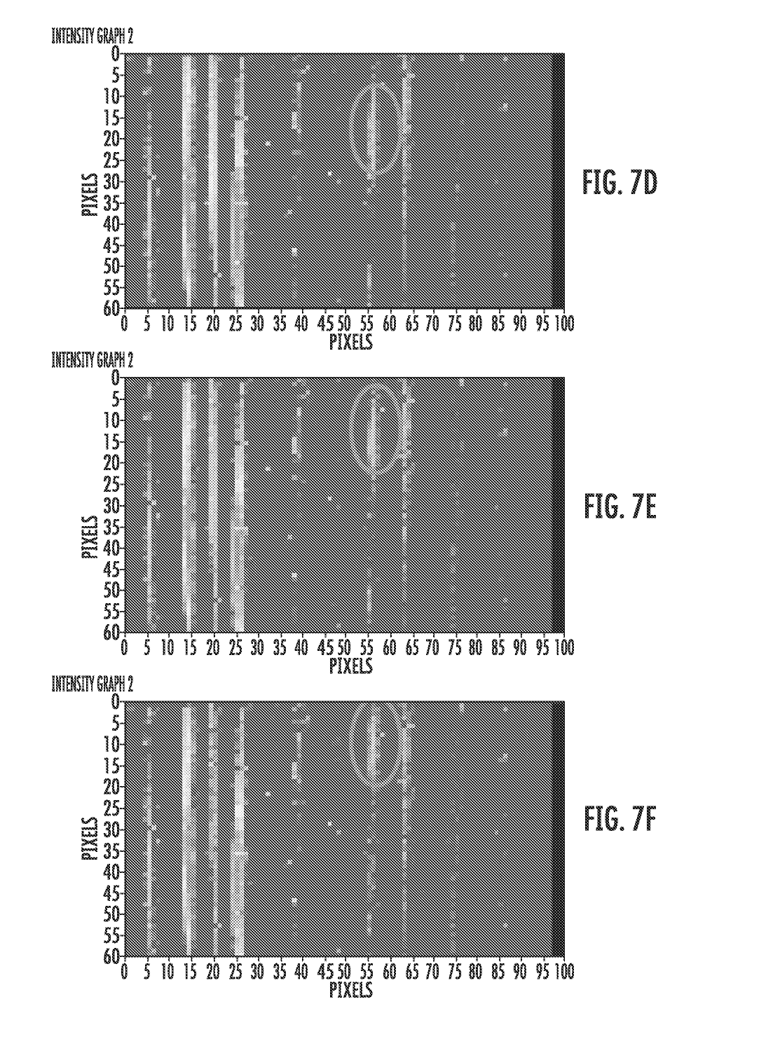

FIG. 7A-7F shows the output of a 2-dimensional CCD detector of sample is flowing through one of the capillaries. In frame 7A the sample starts off in the blue zone (zone 602, FIG. 6). In frame 7B, as the sample migrates through the length of the capillary window, it goes through the green zone (zone 603, FIG. 6). The sample continues to migrate through the capillary, as shown in frames 7C, 7D, 7E, and 7F. When the sample reaches frame 7F, it is in the “red” zone (zone 605, FIG. 6).

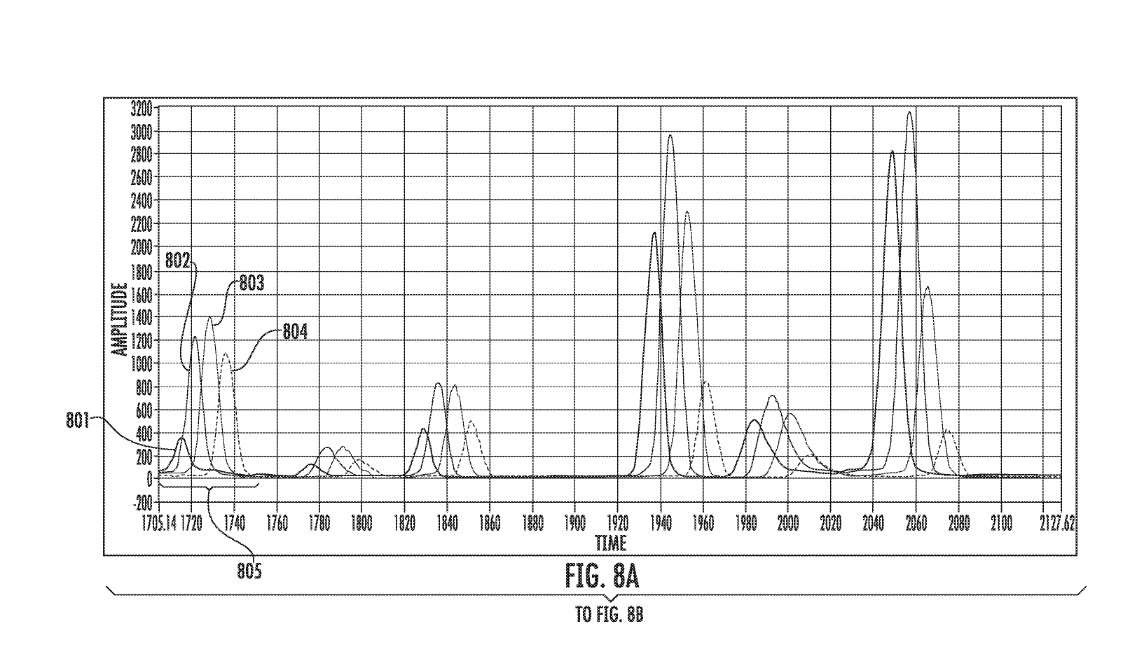

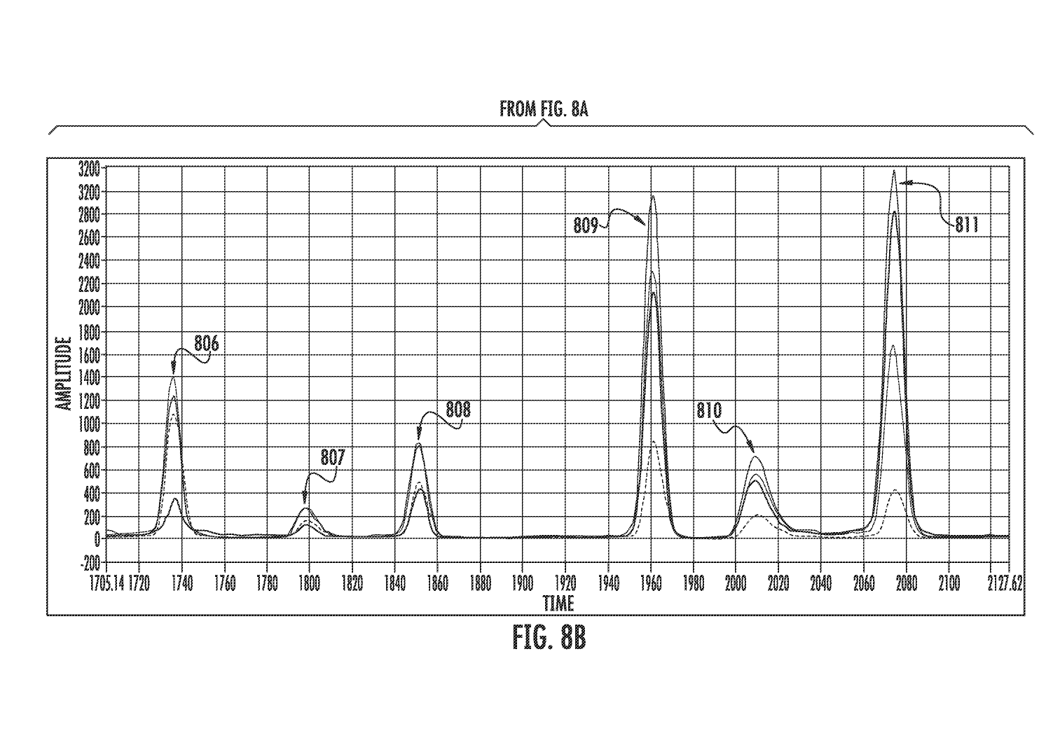

FIG. 8A and FIG. 8B shows the output of the 2-dimensional CCD detector as 6 separate dyes are passed through the system. The dyes correspond to the numbers 806, 807, 808, 809, 810, and 811 in FIG. 8B.

Consider dye 806 (FIG. 8B). As the data is gathered off of the CCD array, the peak corresponding to dye 806 goes through the four zones, (zone 602, 603, 604, and 605). One peak is recorded for each zone, resulting in a total of four peaks. In this case, for dye 806, there are 4 peaks: peak 801 (FIG. 8A) corresponding to a blue color (zone 602); peak 802 corresponding to a green color (zone 603); peak 803 corresponding to a yellow color (zone 604), and peak 804 corresponding to a red color (zone 605). Note that the time increases for each zone, because it takes time for the sample to pass through each zone sequentially.

The peak with the highest corrected light intensity corresponds to the color of the compound, which in this case is yellow. That is, the maximum fluorescent intensity of the 4 zones corresponds to the color of the species migrating through the capillary window.

A computer program which is part of the invention and is described in detail below is used to apply a time-shift correction, merge all peaks corresponding to the 4 separate zones into a single, overlapped peak, and to determine the maximum fluorescent intensity of the set of peaks.

In this case, peak 806 is yellow, corresponding to a compound that emits yellow florescent light, peak 807 is blue, corresponding to a compound that emits blue fluorescent light, and peak 811 is blue corresponding to a compound that emits blue fluorescent light.

For illustrative purposes, assume you have an allelic ladder that is derivatized with a fluorophore such that it fluoresces in the red. Thus, by monitoring the “red” channel (zone 605 in FIG. 6), you are monitoring the presence of the ladder. With a linear filter, you are monitoring several colors simultaneously and to determine if the compound is “red”, you need to determine the maximum intensity of each color. As each element of the ladder migrates through the window and the corresponding linear filter, the color will change from blue (zone 602) to green (zone 603) to orange (zone 604) and finally to red. The intensity of each color is monitored and the color corresponding to the maximum color intensity is the “color” for that compound. In this case, assume that for a ladder element you observed the following arbitrary sum of intensities for each zone (color): Blue=32, Green=43, Orange 49, Red 67. In this case, since red is the maximum intensity, we know that we are observing a red peak, which in this case is the ladder.

For the current invention, the output of the linear filter can be divided into a maximum of up to n zones, where n is the number of pixels in the y-direction. For the 2-dimensional array depicted in FIG. 6, the 60 pixels in the y-axis can be divided into 60 zones, with each zone representing a different color. A preferable number of zones is 5, corresponding to a 5 color system, which is the number of pixels in the y-direction divided by 5, corresponding to 12 pixels per zone in FIG. 6. An even more preferable number of zones is 6 corresponding to a 6 color system. Another preferable number of zones or colors is 7, corresponding to a 7-color system. Yet another preferable number of zones or colors is 8, corresponding to an 8-color system. The y-axis can be grouped into zones with differing numbers of pixels for each detected color. For example, one color zone may use 12 pixels, while another zone uses 5 pixels. Non-detection zones may be used. For example a two-color system may be used with one color corresponding to pixels 1-15, and the second color corresponding to pixels 30-60, with pixels 16-29 as a non-detection gap of pixels that are not measured.

### Example 1

### Generating Electropherograms from a CE Device Coupled with a Linear Filter (FIG. 8)

A Fragment Analyzer™ (Advanced Analytical Technologies) was modified with a combination of a 532 nm and a 473 nm laser. Light from the lasers was delivered through fused silica fiber light guides at an angle of approximately 60 degrees relative to the plane of the capillary detection windows. A12-capillary array with 45 cm (effective length) and 50 cm (total length) with a 75 um i.d was used. A linear variable filter (JDSU, 400-700 nm, index matched to air, Filter length 8.87 mm) was placed directly behind the capillary detection windows, before the camera lens (FIG. 5A). A set of six dye-labeled single-stranded DNA oligomers with a size range of 100-500 nucleotides (using dyes selected from the set of FAM, JOE, TMR, ROX, or CCR) were injected via electrokinetic injection of 9 kV for 30 seconds. A water soluble gel based on those described in U.S. Pat. No. 5,096,554 was used for an electrophoresis gel. A voltage of 10 kV for 60 minutes was applied for electrophoretic separation.

### Example 2

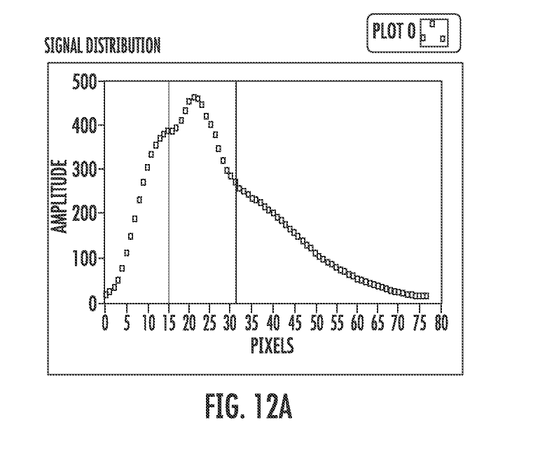

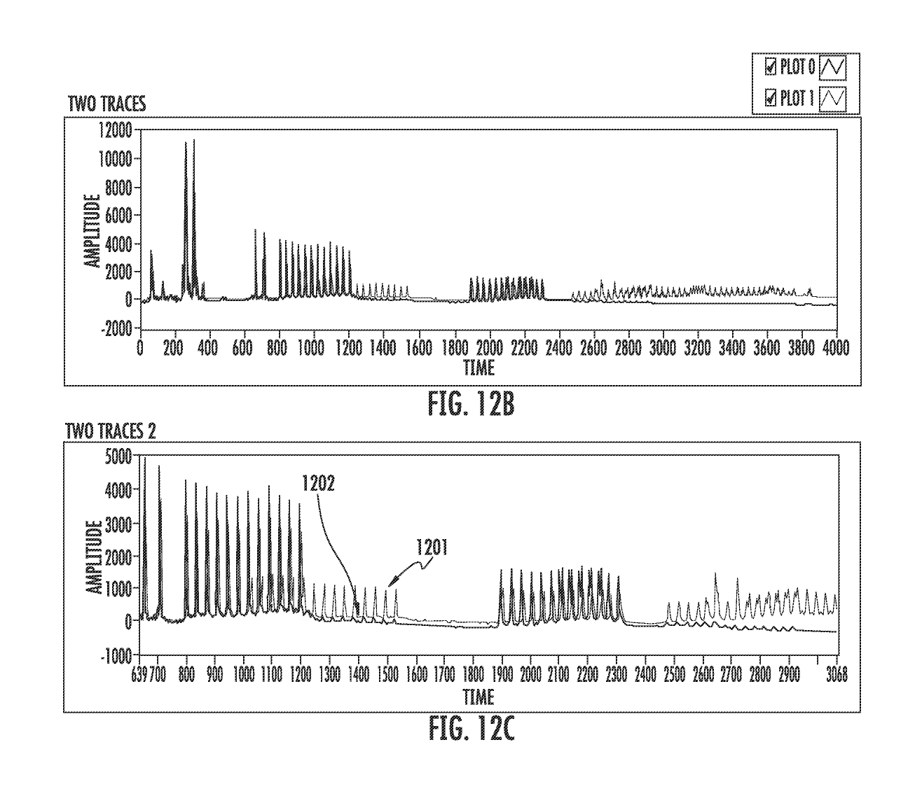

### FIGS. 12, 13, 16, 17

The same conditions an instrument used for Example 1 were used, except that the linear filter was placed directly in front of the CCD (FIG. 5B), and that instead of using dye-labeled oligomers an dye-labeled allelic ladder was used, with sizes ranging from 100 nucleotides to 600 nucleotides.

### Time-Shift Correction

This invention also includes a computer method and algorithm for correcting the time-shift of multicolor peaks. FIGS. 8A and 8B show an example of the time shift associated with several different peaks of an electropherogram corresponding to different monitored zones of the linear filter. Peaks 801, 802, 803, and 804 correspond to the intensity vs. time profile for 4 different zones of the linear filter. When a time-shift correction is applied, the peaks corresponding to all 4 zones of the linear filter are merged into a region with the same apex positions as shown in FIG. 8B, as peak numbers 806, 807, 808, 809, 810, and 811.

The general approach to performing a time-shift correction is to determine the velocity of analytes through the capillaries as a function of time, and then to correct the time shift by re-indexing the times associated each y-axis pixel of the output of the CCD array (corresponding to the wavelength change of the linear filter). It can be appreciated that there are many methods for determining the velocity of analytes through a capillary, with a subsequent application of a correction factor to correct for the apparent observed time shift. We give one specific of an algorithm below.

A specific example of one method for correcting the apparent time shift of peaks associated with different monitored zones of the linear filter is given below. This method corrects each data set by applying data inherently contained within each data set—and does not use any external calibration curves or measurements on the capillary electrophoresis system. The method uses only the output of the CCD array detector for the time-shift correction.

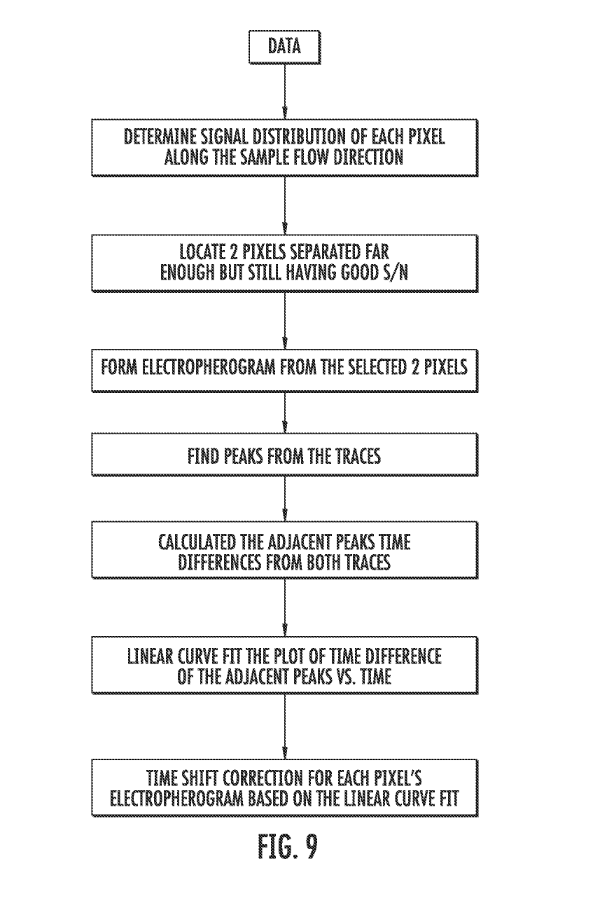

FIG. 9 shows a flow-chart for the computer-based correction of time-shift corresponding to different recorded zones of the output of the linear filter.

In order to accurately apply a time-shift correction, a sample with at least two measureable peaks must be injected and analyzed on each capillary of the multiplex capillary system. Preferable a sample with at least three measureable peaks is evaluated.

In this example, there are seven steps in applying a time-shift correction (FIG. 9)

### Step 1: Determine the Signal Distribution of Those Pixels Corresponding to the Internal Volume of a Capillary Along the Sample Flow Direction.

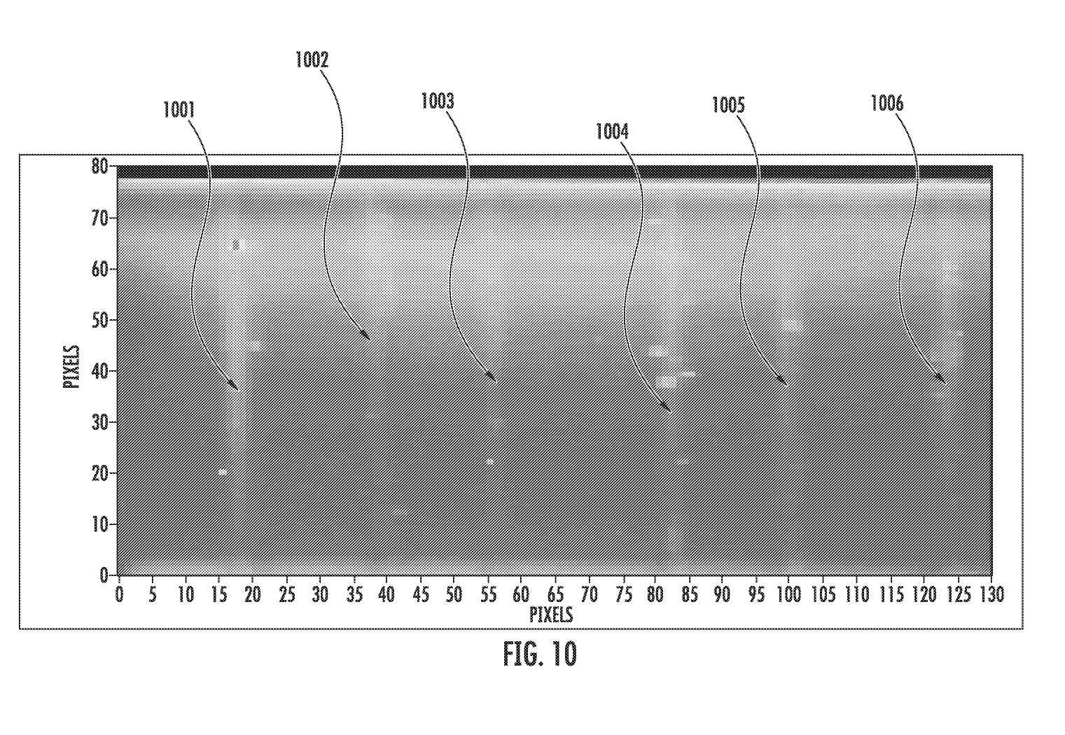

Consider FIG. 10, which is a single 2-dimensional snapshot of a multi-channel electropherogram. In this case the 2-D image contains the image of 6 capillaries within a capillary array, shown as 1001, 1002, 1003, 1004, 1005, and 1006. The x-axis is the capillary location and the y-axis is the direction of flow of the capillary. The y-direction of the CCD represents a capillary detection window of approximately 6 mm. Thus, pixel zero on the y-axis corresponds to the bottom edge of a 6 mm window, and pixel 80 corresponds to the top end of the 6 mm window. There are 6 capillaries located at x-pixel locations of about 18, 40, 55, 83, 99, and 125. The y-direction is directly correlated with the wavelength of the linear variable filter, which in this case ranges from 500 nm (pixel zero on the y-axis) to 700 nm (pixel 80 on the y-axis). The linear variable filter is in the direction of flow of the capillaries, which means that a change in detected wavelength occurs in the direction of flow of the capillaries.

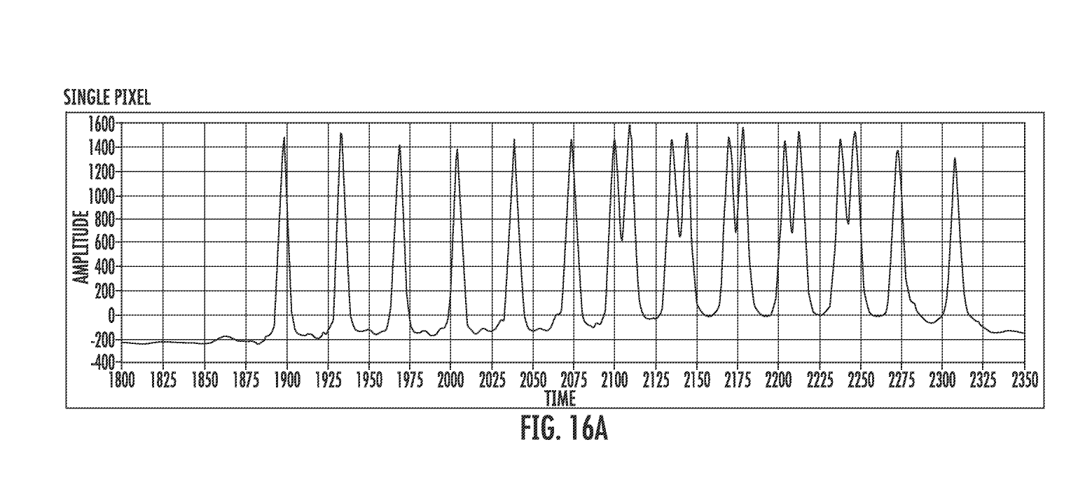

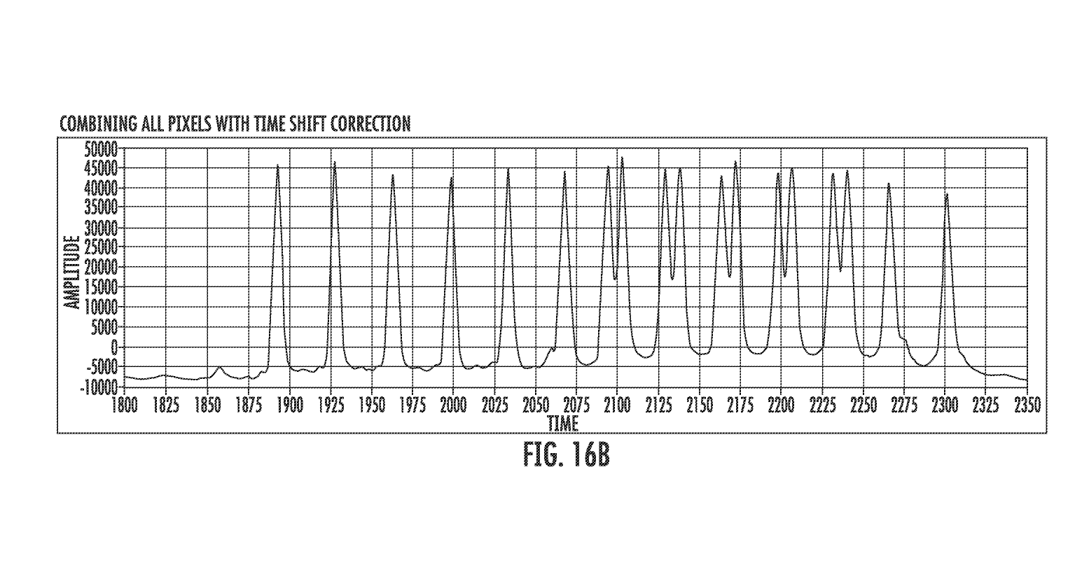

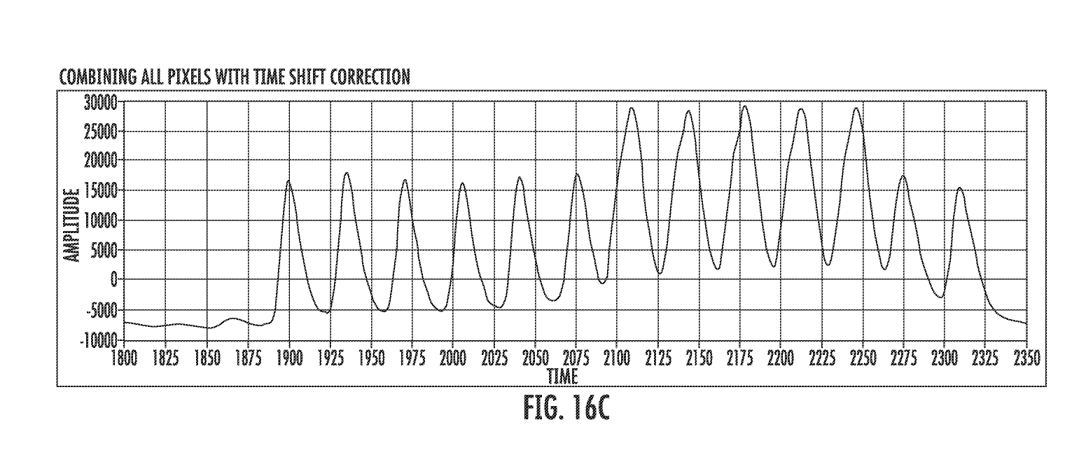

The capillary outer diameters may range from 90 to 1000 microns, with a preferred range of 150 to 350 microns. The inner diameters may range from 2 microns to 700 micron, with a preferred range of 50 to 100 microns. Consider the first capillary on this 6-capillary array. The location of the center of this capillary corresponding to the internal void of the capillary (containing electrophoresis gel) is at pixel location 18 (FIG. 10, location 1001). The walls of the capillary are about from 15-17 pixels, and 19-20 pixels. Only the x-pixels corresponding to x-axis location 18 are used for this first capillary. Pixels corresponding to the space between capillaries (for example, x-pixels 21-39) are not used to process data. The entire set of pixels for the first capillary (internal volume containing gel) using (x, y) coordinate point geometry are (18,1), (18,2) . . . (18,80). If a single pixel were used to monitor the fluorescence intensity vs. time, (say pixel 18,1), then an electropherogram similar to FIG. 16A would be obtained.

Using this first capillary as an example, at x-pixel location 18, the signal distribution as a function of y-axis pixel is shown in FIG. 12A. This is obtained using all the pixels corresponding to capillary 1 ((18,1), (18,2) . . . (18,80)) for all the frames of the entire electropherogram. For example, for a 60 minute run with a 1 second frame or acquisition rate corresponding to 60*60=3600 saved 2-dimensional images, pixel 1 on the x-axis of FIG. 12A is obtained by summing the base-line corrected intensities of the y-dimensional pixel 1 over the 3600 images: (18,1)(time1)+(18,1)(time2)+ . . . + . . . +(18,1)(time3600). Likewise, Pixel 2 on the x-axis of FIG. 12A is obtained by summing the base-line corrected intensities of the y-dimensional pixel 2 over the 3600 images: (18,2)(time1)+(18,2)(time2)+ . . . + . . . +(18,2)(time3600). This summation process is repeated for all 80 pixels of the y-axis of the CCD detector. The plot in FIG. 12A represents the total summed base-line corrected intensities of the y-dimensional plot over the entire time of the electrophoresis. This signal distribution varies with the type of sample analyzed. For example, in the case shown in FIG. 12A, the distribution is more blue (corresponding to the blue range of the linear variable filter). In the single frame snapshot of FIG. 10, the sample is more red (corresponding to the red range of the linear variable filter). However, the single frame of FIG. 10 is not representative of the signal distribution, because FIG. 10 represents a single snapshot, whereas the signal distribution shown in FIG. 12A represents the signal across the entire electrophoresis run. There are several methods for obtaining the signal distribution. One method is to sum the base-line corrected intensities of each pixel (i.e. (18,1) frame 1+(18,1) frame 2+(18,1) frame 3 . . . +(18,1) frame 4) and divide by the total number of frames (which in this case is 3600). Another is to sum the baseline corrected intensities without dividing by the total number of frames. Another method is to use techniques such as Fast Fourier Transform for obtaining an AC signal component over all captured frames for each pixel. The exact method for obtaining the signal distribution is not important, as long as final data set represents signal intensity over time for the entire number of pixels in the y-direction. The signal distribution is obtained separately for each capillary in the array. In this example, a signal distribution is obtained for each capillary 1-6, corresponding to x-pixel locations 18, 40, 55, 83, 99, and 125.

Step 2: Locate 2 Pixels on the y-Axis Separated Far Enough Away in Time from Each Other to Get a Good Time Separation, but Still Having a Good Signal-to-Noise Ratio (S/N) (Minimum Signal-to-Noise Ratio of 5). This is Repeated Separately for Each Capillary.

FIG. 7 shows six single 2-second interval snapshots of the two-dimensional detector as a function of time. Several capillaries, 611, 612, 613, 614, 615, 616, 617, 618, 619, 620, 621 are shown, with each capillary location located in the x-direction. The first four capillaries are located at x-pixel location 5, 10, 15 and 20 pixels. The seventh capillary (617, FIG. 7) is located at pixel position 55. The y-axis is the imaged window length of the capillaries, and is also the output of the linear filter in the direction of flow. Over the passage of time, the flow of analyte in the capillary moves from the bottom of the 2-dimensional image of the capillary array window to the top of the 2-dimensional image. This is indicated by the oval circles, 701 (FIG. 7) for capillary 7. Over a several second sequence, the analyte moves from the lower part of the image (Panel A) up through the array (FIG. 7. ovals 701 on Panel B, C, D, E) until the analyte reaches the top of the image in Panel F. The pixels in the y-direction represent the length of the capillary window and also the output of the linear filter from about 500 nm (pixel 0) to 700 nm (pixel 80). In this case, it takes about 15 seconds for the analyte to move through the entire imaged area of the array window.

A monitoring of a single pixel location for capillary 7, for example x-y coordinate of (55,45) (Capillary location 617 in FIG. 6) will result in a single peak corresponding to the analyte as it moves past the detector window. If one monitors two pixel locations independently for capillary 7, for example x-y coordinate of (55,35) and x-y coordinate (55,45), (617 in FIG. 6) then one will observe a single peak for each pixel channel that is monitored, but there will be a time delay between the peak maximum. The peak at location (55,45) will occur a few seconds after the peak detected at (55,35). The goal of the computer algorithm is to apply a time-shift correction so that the peak monitored at both pixel locations occur at the same time without a time-delay or time shift.

To perform a time-shift correction, the velocity of analyte at the detector space as (delta pixels)/(delta time) must be determined (i.e. pixels per seconds).

To determine the velocity of an analyte through the array window (and across the imaged linear filter in the direction of flow) there are two critical criteria:

Criteria 1:

The two different pixels used to monitor the peak position vs. time (i.e. the pixels in the y-direction) must be separated by a minimum distance to get adequate time resolution. For example, if one were to monitor pixel locations (55,50) and (55,51) there is only a 1-pixel difference in the y-direction. As an analyte moves through the capillary, the maximum peak intensity measured by pixel 50 and 51 will be less than a second. However, if one uses pixel locations (55,50) and (55,20), then the maximum peak intensity of the analyte as monitored by the two pixel locations may be separated by 6 or 7 seconds. A minimum difference of 1 pixel is required to calculate an analyte velocity (pixels/second). A preferred embodiment uses a difference corresponding to at least 10% of the y-axis pixel count. In this case, the y-axis has 60 pixels, so a preferred minimum separation of 10% of the pixel range for determining analyte velocity is 6 pixels. It is even more preferable to use a difference corresponding to at least 20% of the y-axis pixel count. In this case, the y-axis has 60 pixels, so a preferred minimum separation of 20% of the pixel range for determining analyte velocity is 12 pixels.

Criteria 2:

The signal-to-noise ratio of the signal distribution on the selected two pixels of the y-axis (linear variable filter) must be high enough to adequately determine the presence of an analyte peak. For example, if pixel 0 is monitored, but the signal intensity never gets above the baseline intensity, then the analyte velocity through the array window cannot be adequately measured, since there really cannot be any peak intensity monitored. For any pixel selected for calculating the velocity of analytes through the capillary, the peak amplitude must be at least 3 times the S/N ratio of the baseline. It is preferable that the signal of the selected pixel have a peak maximum of at least 10 times the S/N ratio of the baseline.

There are a variety of methods for choosing which two pixels to monitor for applying the time-shift correction. One method is to calculate the peak maximum of the signal distribution (FIG. 12A) and to choose pixels on either side of the peak corresponding to ½ of the peak maximum, and then checking to see that the selected pixels meet the minimum peak amplitude of 3 times the S/N (or 10 times the S/N preferred) and the preferred level of pixel separation (at least 10% or 20% of the pixel range). Another method is to calculate the peak maximum and select an arbitrary number of pixels above and below the peak maximum (for example, if the peak maximum is at 25 pixels, choose 25+10 pixels and 25-10 pixels, or pixel locations 15 and 35. Another method is arbitrarily pick two regions of the y-axis range, for example locations ⅓ and ⅔ of the y-axis pixel range—and checking to see of the signal intensity meets the S/N requirement. If the y-axis pixel range was 0 to 60, then locations 20 and 40 could be used, again, checking to see if the S/N requirements are met. The method for selecting the two pixel locations is not critical, as long as the two tests for pixel location are met (minimum amplitude of the pixel location and desired pixel separation).

Step 3: Form an Electropherogram Using the Intensity Vs. Time Output of the 2 Selected Pixels.

When running an electrophoresis sample for time correction, a sample with at least 2 analytes (at least 2 peaks) with a fluorescence emission within the range of the linear variable filter must be used. In this example, the linear variable filter has a range of 500-700 nm, so a sample with at least one analyte that emits light in the 500-700 nm range is required.

Even more preferably, a sample with at least three analytes (three peaks) is analyzed to generate an electropherogram.

Even more preferable, a sample with at least 10 analytes, such as an size standard is used to generate the electropherogram.

The analytes may have mixed fluorophores. For example, a mixed allelic standard with FAM, ROX, and TAMRA dyes may be used.

If the intensity vs. time output of a single pixel location (for example, pixel location (55,15) for capillary 7 (701) in FIG. 7) is used to monitor the output of the capillary array (through the linear filter), then an electropherogram such as that shown in FIG. 16 panel A is obtained. Peaks corresponding to analytes are observed as they pass the selected pixel location.

If two separate electropherograms are obtained using the intensity vs. time output of two different y-pixel locations corresponding to the same capillary, then the electropherograms similar to FIGS. 12B and 12C are obtained. The two separate lines in FIGS. 12B and 12C correspond to the two different electropherograms obtained with intensity vs. time output the two different pixels. FIG. 12B and FIG. 12C are the same set of electropherograms, but 12C is an expansion (zoomed) version of FIG. 12B. Note that the relative peak intensities of the two electropherograms are different from each other, because different peaks have different fluorescent emission spectra, and thus respond differently at the different y-axis pixel locations (because the y-axis pixel locations correspond to the linear variable filter in the direction of flow). Regions 1201 and 1202 (FIG. 12C) show different peak intensities. The light-colored line shows significant peak intensity while the black line shows reduced peak intensity.

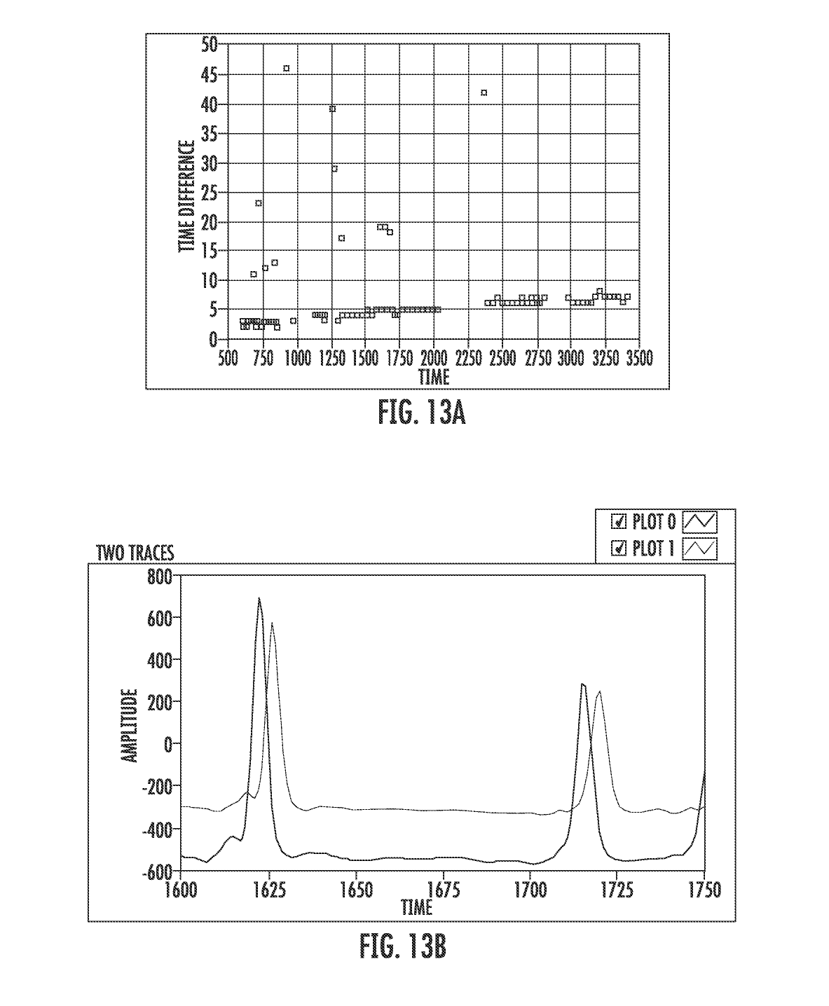

Note that in FIG. 12C, there is a time-shift between the measured peaks on the superimposed electropherograms. This is due to the migration time of the analyte as it passes through the two different pixel locations. This is shown more clearly in FIG. 13B, which shows a zoomed-in portion of FIG. 12A. Two different analytes are shown, with two peaks separated by a few seconds.

Step 4: Find Peaks from the Electropherogram Traces.

In this step, each electropherogram is analyzed for peaks, and all peak locations are determined. User-selectable peak criteria are used to determine the parameters for peak-picking (for example, minimum peak height, peak width, smoothing parameters, smoothing functions, baseline correction, etc). The art of peak-picking in capillary electrophoresis is well known. Examples of this art are covered in Data Analysis and Signal Processing in Chromatography (A. Felinger, 1998) and Chromatographic Integration Methods (N. Dyson, 1990), the contents of which are incorporated by reference.

The output of this step is a peak table for each electropherogram with peak number vs time. An example peak table is shown in Table 1:

| | |
|---|---|
| Peak Number | Peak Time |

Electropherogram 1

| | |
|---|---|
| 1 | 1005 |
| 2 | 1045 |
| 3 | 1211 |
| 4 | 1350 |
| 5 | 1420 |
| 6 | 1503 |
| 7 | 1550 |
| . . . | |
| . . . | |
| . . . | |

Electropherogram 2

| | |
|---|---|
| 1 | 1007 |
| 2 | 1048 |
| 3 | 1215 |
| 4 | 1356 |
| 5 | 1427 |
| 6 | 1511 |
| 7 | 1559 |
| 8 | 1665 |
| . . . | |
| . . . | |
| . . . | |

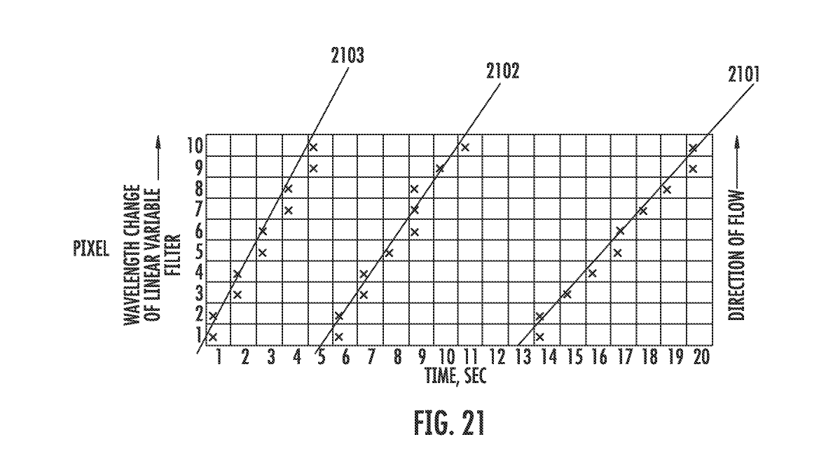

The number of peaks does not have to be the same for each electropherogram. For example, FIG. 20 shows the electropherograms generated via the 2 different pixel locations, and they are very different because of the different dyes associated with the analytes in the sample. The peaks 2001 are picked up by the 2^{nd} pixellocation but not the first pixel location, because the linear filter allows the fluorescence light to pass through at the second pixel location, but not the first pixel location.

Step 5: Calculate the Adjacent Peak Time Differences from Both Traces, and Determine a Correlation Equation that Relates Inverse Peak Velocity (Delta Time Vs. Delta Pixels) Vs. Electropherogram Time.

Consider the output of a single vertical row of pixels on the 2-dimensional CCD array, corresponding to a single capillary. Assume 1 frame per second is acquired. If this single vertical row of pixels is plotted vs time (Frame 1 second 1, Frame 2 second 2 etc), then the image shown in FIG. 21 is obtained. As the analyte peak moves through the capillary, the peak is detected at different locations on the y-axis. When the y-axis is plotted as a function of time, the peak location is observed at different times. The slope of the line (2101) is the velocity of the analyte through the capillary at the detector space.

FIG. 21 represents three analytes (three peaks) running through the capillary at different times. As the time of the electropherogram increases, the rate at which the analytes moved through the capillary are slower. As a result, the slope of the lines (i.e. the velocity of the analytes through the capillary) are less (i.e. slower) for peaks coming out at later times in the electropherogram.

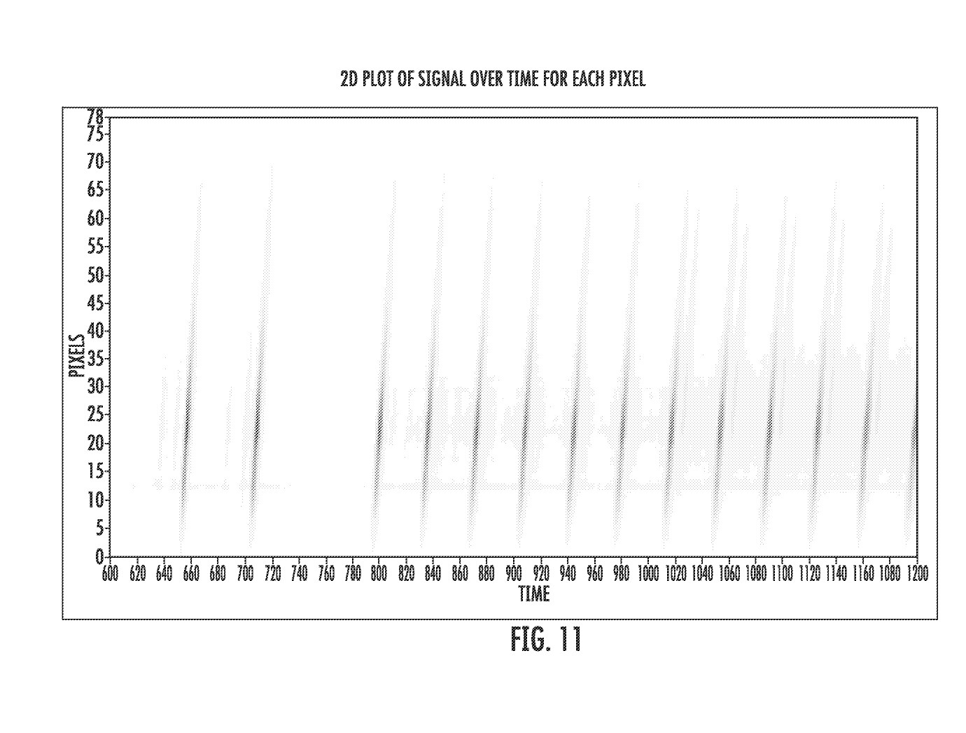

FIG. 11 is equivalent to FIG. 21, but represents real electropherogram data obtained from the y-axis of a two-dimensional detector corresponding to a single capillary. In FIG. 11, an allelic ladder corresponding to 19 peaks is shown, The first peak begins to pass the detection window at about 650 seconds (as indicated on the x-axis), and with time passes through the entire length of the y-axis of the CCD detector (from about 650 to 665 seconds). The slope of the line decreases with larger fragments coming off at later times, although this is not apparent to the human eye in this figure.

To correct for the apparent time shift (or mobility shift) of the separate monitored zones of the linear filter, the velocity of species moving through the capillaries is determined by monitoring the peak intensity migration on the 2-dimensional CCD detector with time. A peak velocity factor is obtained, corresponding to the measured migration of imaged peaks through the linear variable filter onto the y-axis (direction of flow) on the CCD detector. There is an instantaneous velocity element, given by equation 1:

Instantaneous Velocity=Delta (pixels)/Delta (time). Equation 1

This instantaneous velocity is the slope of the lines In FIG. 21 and FIG. 11.

As the electropherogram progresses, the velocity of peaks through the capillaries slow down. And thus, there is a deceleration given by the following equation.

Acceleration (deceleration)=[Delta (pixels)/Delta (time)]/Delta time (Equation 2)

To apply a time correction, the inverse instantaneous velocity can be calculated as Equation 3:

Inverse instantaneous velocity=Delta (time)/Delta (pixels) (Equation 3)

The time correction factor is calculated as the inverse velocity over the time of the electropherogram (Equation 4)

Time Correlation Factor=[Delta(time)/Delta(Pixels)]/Delta Electropherogram time Equation 4

To determine the inverse instantaneous velocity as shown in Equation 3, the time differences corresponding to the differences in peak times using the two selected y-axis pixels (Step 4) are calculated, and a table of time (of peak location for the first electropherogram) vs. time difference is created. To calculate the time difference for each peak, the following process is used: A) Determine the peak 1 time in electropherogram 1. B) Determine the nearest peak occurring after peak 1 in electcropherogram 2. C) Calculate the time difference. Table 2 shows the calculated time differences for the peaks shown in Table 1. The time difference is calculated as the time of Peak(i)(electropherogram 2)—Peak(i)(electropherogram 1). Note that the peak in electropherogram 2 that is closest in time after the peak in electropherogram 1 is used for the calculation.

TABLE 2

| Peak | Time Difference (T2 − T1) |
|---|---|
| Time | (between pixel 2 and Pixel 1) |
| 1005 | 2 |
| 1045 | 3 |
| 1211 | 4 |
| 1350 | 6 |
| 1420 | 7 |
| 1503 | 8 |
| 1550 | 9 |

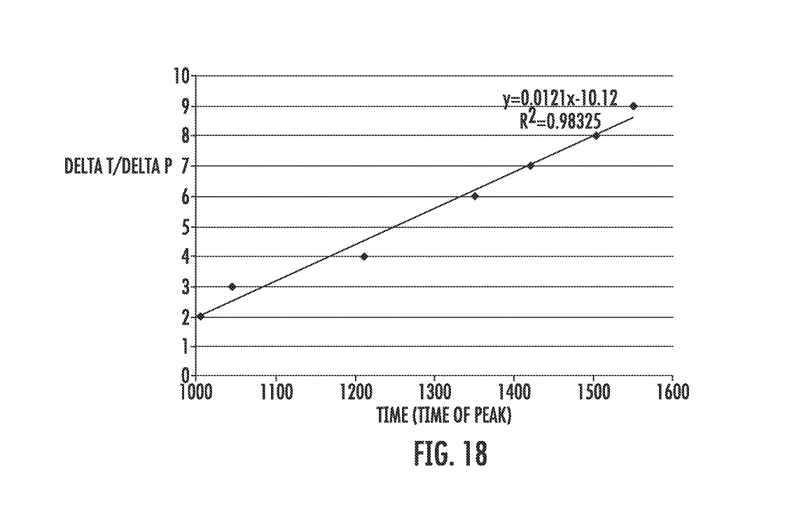

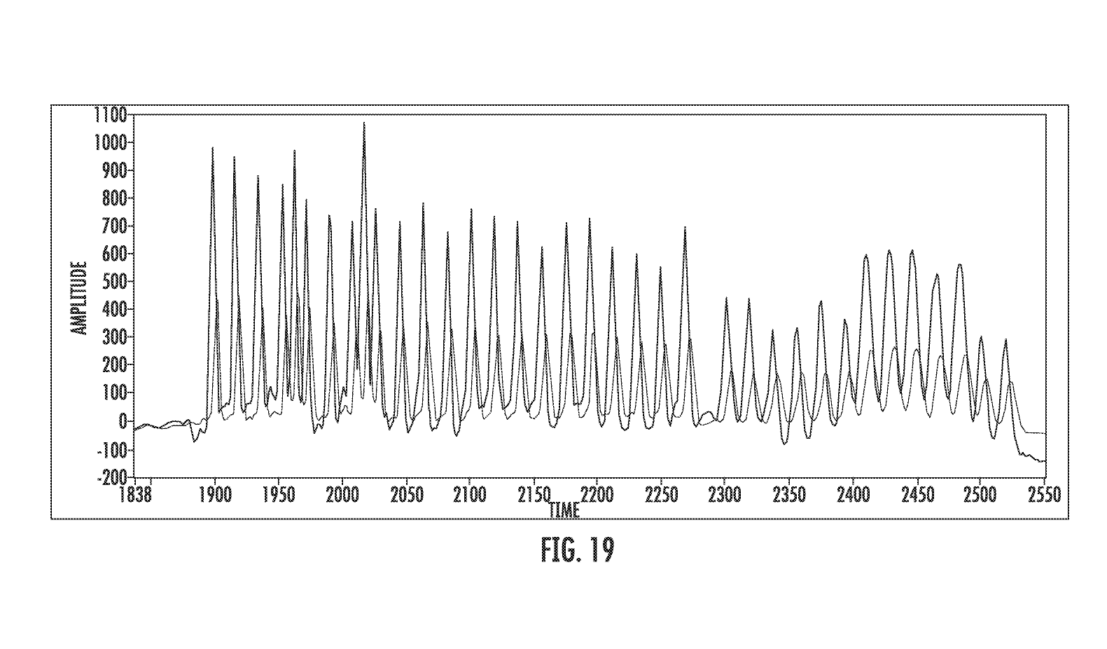

FIG. 18 shows a plot of Peak time on the x-axis (From electropherogram 1) vs (peak time difference/pixel difference) (calculated from peaks on electropherogram 2—peaks on electropherogram 1) on the y-axis. This is a plot of the inverse velocity vs. electcropherogram time. In this case a linear-least-squares equation is used to establish an equation of (delta T vs delta P) vs peak time. The slope of the line is the inverse velocity vs. electropherogram time.

In many cases, the number of peaks in the two electropherograms are not the same. This situation occurs because the two different pixel locations correspond to different color regions of the linear filter, and the sample may have different color peaks. Thus, the electropherogram and pixel location 1 may have many different peaks than at electropherogram at pixel location 2. For this method to work, it is critical that the majority (>50%) of the peaks are picked up in both the pixel 1 and pixel 2 location. Other reasons for different peak numbers between the two electropherograms generated in the two pixel location are that the peak picking routine picks up anomalous peaks, shoulder peaks or other unexpected anomalous peaks that may or may not be present in both electropherograms. An important part of this invention is that the time-shift correction algorithm can easily handle these extra peaks.

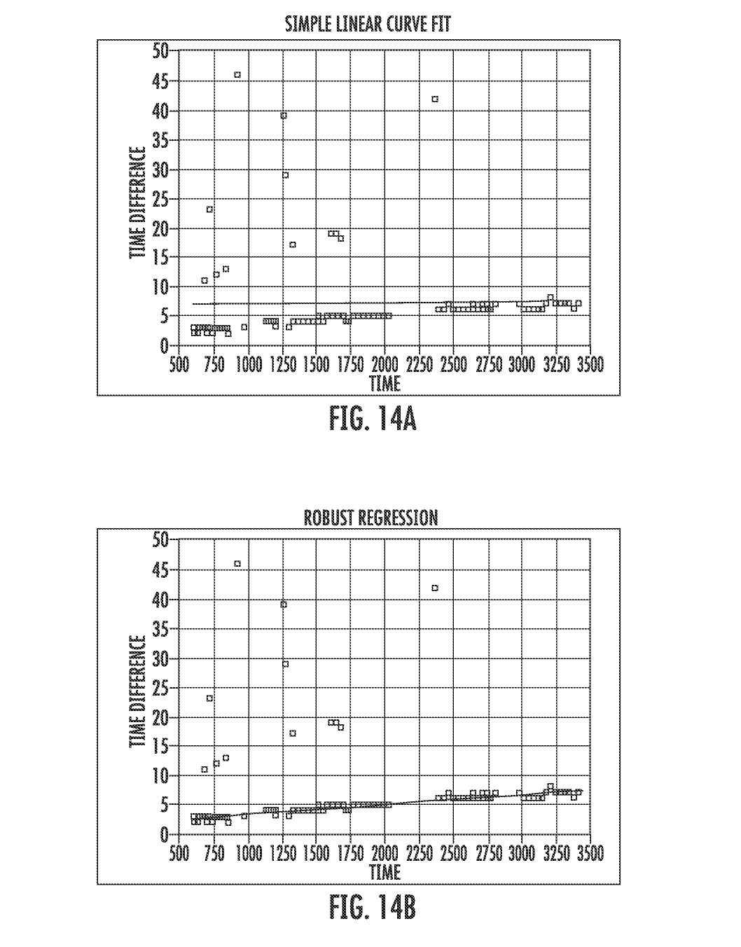

FIGS. 13A, 14A, and 14B show a plot of (delta time/delta pixel)/(electrophereogram time) for two different electropherograms obtained at the two different pixel locations (Step 4). The method is to generate an initial plot of the x-y plot of the data and then fit the data with an appropriate linear fitting routine. In FIG. 14A, a linear least squares fits is used. In FIG. 14B, a “robust regression” fit is used. (Draper, David (1988). “Rank-Based Robust Analysis of Linear Models. I. Exposition and Review”. Statistical Science 3 (2): 239-257, the contents of which are incorporated by reference). Points that do not fall onto the calculated regression line (+/−10%) are rejected, and a new plot is generated. This process is iterated until all points fall onto a straight line with +/−10% accuracy.

The regression line represents the fitted equation of inverse velocity vs. electropherogram time.

### Step 6. Apply the Time-Shift Correction to the 2-Dimensional File.

The data-file output of an electropherogram using the present invention is an array of data consisting of the signal intensity of columns of pixels corresponding to the internal fluid volume of each single capillary detection window, captured over time. For a column consisting of 23 pixels in the y-direction corresponding to the internal volume of a capillary with a total collection time of 2000 seconds and a frame rate of 1 image per second, the data is stored in a 2-dimensional array with an array size of 23×2000. Normally the data is stored as pixel intensity vs. time, where time is inferred from the number of samples obtained, which in this case is one sample per second. This inferred time can be envisioned as a time-index array.

Table 3 below, shows a time index array for a portion of a 2-dimensional file for a 23-pixel column collected over 2000 seconds. Only the time from 1000 seconds to 1011 seconds is shown. The y-axis represents a single column of pixels on the CCD detector corresponding to a single capillary location (i.e. the image of the internal fluid volume of the capillary). The x-axis is electropherogram time, t, in seconds. The highlighted cells represent the times at which a peak migrates through the capillary window before a time shift. The goal is apply a correction factor to the time grid so that the peak migration times occur simultaneously for a single column in the array.

The corrected time is:

T(p,t)=T(p,t)−[(t*slope+intercept)/delta pixels]*P (Equation 6)

Where

T(t,i) is the corrected time of each pixel on the time grid (as a function of pixel location and time, t)

t=time, seconds

slope=slope of the inverse velocity vs. time plot (step 5)

intercept of the inverse velocity vs. time plot (step 5)

P=pixel location (y-axis), which ranges from 1 to 23 in Table 3 below.

In order to force the peak to migrate at exactly the same time for a single column of pixels, each time array index for the pixels 4 through 23 must be shifted to the left by applying the correction factor in Equation 6, above. A correct application of the equation (and a correct calculation of the time correction factor in Step 5) will shift the time array elements of each pixel to the left (and their associated intensity values) so that the peak migrates at exactly the same time across all pixels in the y-direction. Table 4 show the corrected time, after applying Equation 6.

TABLE 3
Time grid of pixel location vs time. Highlighted times represent peak locations as an analyte
migrates through the capillary.

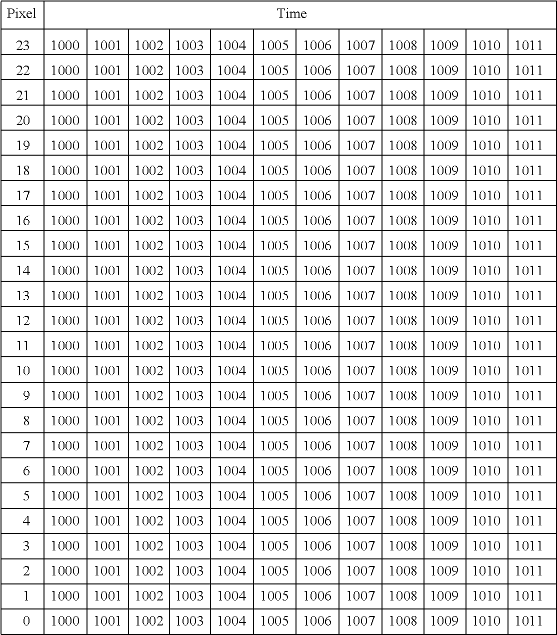

TABLE 4

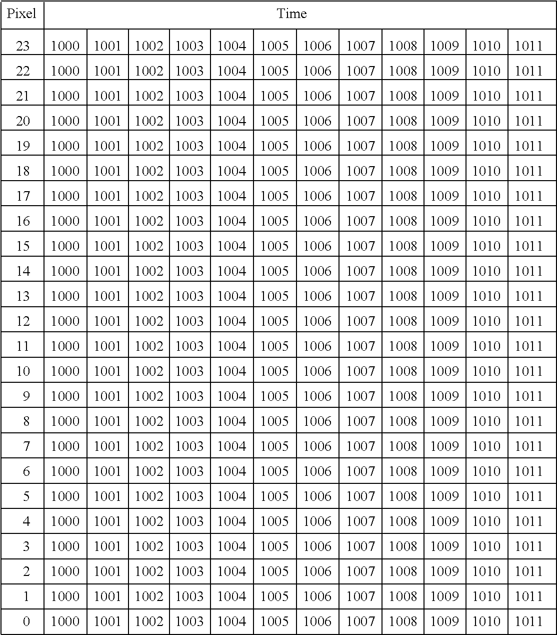

As alternative, one could transform the array of data to the corrected time shift with reshuffling the data as discussing below. For example, assuming the pixel 0 electropherogram is the trace to match. All the subsequence pixel electropherograms data will be shuffled according to the following method. For array of data [PxT] (23×2000 as in Step 6), where P represents # of pixels along the wavelength and T is the time index, one could use the equation 7 to select the data from corresponded time index (i) for each pixel to transform the array of data into time-shifted corrected array of data F(X).F(X)=X(i)

iₜ=(t*slope+intercept)/delta pixels*P+t (Equation 7)

t=time, seconds

slope=slope of the inverse velocity vs. time plot (step 5)

intercept=intercept of the inverse velocity vs. time plot (step 5)

P=pixel location (y-axis), which ranges from 1 to 23 in table 3.

Considering the following example, table 5 lists part of the time index of pixel 0 from 1000 to 1013 second,

TABLE 5

| | | | | | | | | | | | | | |
|---|---|---|---|---|---|---|---|---|---|---|---|---|---|
| Time | 1000 | 1001 | 1002 | 1003 | 1004 | 1005 | 1006 | 1007 | 1008 | 1009 | 1010 | 1011 | 1012 |

For pixel 20 and time 1000, one will find corresponded time index as:

I₁₀₀₀=(1000*slope+intercept)/delta pixels*20+1000

and for pixel 20 and time 1001, the i₁₀₀₁=(1001*slope+intercept)/delta pixels*20+1001 and so on for all the corresponded time index. Then one could use the corresponded time index to transform the pixel 20 data into time shifted corrected data by shuffling the data into the right order. For example in this case, at time 1000, one will use the data located calculated by i₁₀₀₀ and at time 1001, one will use position data located at i₁₀₀₁ to form the electropherogram data array at index 1000. Every pixel data array will transform into time shifted corrected data array. All pixels will use the following array index to re-construct the time shifted corrected data array:

P₀=X₀(t₀*slope+intercept)/delta pixels*0+t₀),X₁(t₁*slope+intercept)/delta pixels*0+t₁),X₂(t₂*slope+intercept)/delta pixels*0+t₂), . . . Xₙ(tₙ*slope+intercept)/delta pixels*0+0

P₁=X₀(t₀*slope+intercept)/delta pixels*1+t₀),X₁(t₁*slope+intercept)/delta pixels*1+t₁),X₂(t₂*slope+intercept)/delta pixels*1+t₂), . . . Xₙ(tₙ*slope+intercept)/delta pixels*1+0

P₂=X₀(t₀*slope+intercept)/delta pixels*2+t₀),X₁(t₁*slope+intercept)/delta pixels*2+t₁),X₂(t₂*slope+intercept)/delta pixels*2+t₂), . . . Xₙ(tₙ*slope+intercept)/delta pixels*2+tₙ)

Pₘ=X₀(t₀*slope+intercept)/delta pixels*m+t₀),X₁(t₁*slope+intercept)/delta pixels*m+t₁),X₂(t₂*slope+intercept)/delta pixels*m+t₂), . . . Xₙ(tₙ*slope+intercept)/delta pixels*m+tₙ)

Pₘ is the pixel in the y direction of the capillary detection window while m represents the pixel position

n is the time index

Once the data array is transform to all pixels, each pixel will have different number of data points. One could either zero pad the smaller data array at the end of the data array to match the largest one or truncate the largest data array at the end to match the smaller one for display.

We claim:

1. In a multi-plex capillary electrophoresis apparatus including:
a capillary array with a plurality of side-by-side capillaries that can be filled with an electrophoresis medium;
an LED or laser light source that irradiates light to an electrophoretically separated sample; and a fluid handling system for injecting said capillaries with said electrophoresis medium or other fluids, the improvement comprising:
a. an optical detection system that detects the induced fluorescence from said sample that includes a linear variable filter oriented such that the change in output wavelength of said linear variable filter occurs in the direction of fluid flow in said capillaries.

2. The apparatus of claim 1 wherein the apparatus has capillary windows and a two-dimensional detector and the linear variable filter is positioned between them.

3. The apparatus of claim 2 wherein the linear variable filter is positioned against the capillary windows.

4. The apparatus of claim 1 which includes a two-dimensional CCD detector, and said linear variable filter is positioned against the CCD detector.

5. In a multi-wavelength fluorescence detection system having, a plurality of side-by-side capillaries disposed in a plane, a light source positioned to direct a beam of light through each capillary to induce fluorescent emission from any sample in the capillaries, a light collection lens to collect fluorescent emissions from said samples, and a two-dimensional detector positioned to receive said emissions from said collector lens, the improvement comprising:
a linear variable filter to pass selective wavelength regions of said emissions to said two-dimensional detector simultaneously; and
wherein said light source is positioned at an angle of from about 10 to about 80 degrees, relative to said plane of said side-by-side capillaries.

6. The system of claim 5, wherein the improvement further comprises an LED as the said light source.

7. The system of claim 5, wherein the improvement further comprises a laser light source.

8. The system of claim 5, wherein the improvement further comprises a combination of two or more lasers as said light source.

9. The system of claim 5, wherein the improvement further comprises a combination of one or more LED's with one or lasers as said light source.

10. The system of claim 5, wherein said linear variable filter is located immediately adjacent to said plurality of side-by-side capillaries disposed in a plane, between said plane and said light collection lens.

11. The system of claim 5, wherein said linear filter is located adjacent to said two-dimensional detector.

12. The system of claim 5, wherein said linear filter has an effective filtration range of from 400 to about 700 nm.

13. The system of claim 5, wherein at least seven different wavelength regions are measured simultaneously with the said two-dimensional detector.

14. The system of claim 5, wherein at least eight different wavelength regions are measured simultaneously with the said two-dimensional detector.

15. The system of claim 5, wherein the improvement further comprises the use of an algorithm to correct for apparent time shift in electropherograms obtained for each wavelength region.

16. In multi-color detection systems for multiplexed capillary electrophoresis, the improvement comprising:
using a time-shift correction algorithm to correct for apparent time-shift in electropherograms for each measured wavelength region.

17. The system of claim 16, wherein said algorithm is used to merge all peaks corresponding to at least four separate measured colors of an electropherogram into a single overlapped peak, and to determine the maximum fluorescent intensity of said peak.
